(19) United States
(12) Patent Application Publication
(10) Pub. No.: US 2024/0196252 A1
(43) Pub. Date: Jun. 13, 2024

(54) MANAGING RESOURCES IN A RADIO ACCESS NETWORK

(71) Applicant: Telefonaktiebolaget LM Ericsson (publ), Stockholm (SE)

(72) Inventors: Pablo Soldati, Solna (SE); Luca Lunardi, Genoa (IT)

(21) Appl. No.: 18/287,324

(22) PCT Filed: Apr. 26, 2022
(86) PCT No.: PCT/EP2022/061040

§ 371 Date: Oct. 18, 2023

Related U.S. Application Data
(60) Provisional application No. 63/180,733, filed on Apr. 28, 2021.

(51) Int. Cl. H04W 24/10; H04L 41/147

(52) U.S. Cl. CPC H04W 24/10; H04L 41/147

(57) ABSTRACT

A method is disclosed for managing resources in a Radio Access Network (RAN) of a communication network. The method, performed by a first node in the RAN, comprises obtaining a record of resource status information describing usage, during a historical time period, of RAN resources controlled by a second node in the RAN and predicting, based on the obtained record, resource status information describing usage of RAN resources controlled by the second node during a future time period. The method further comprises performing at least one of using the predicted resource status information describing usage of RAN resources controlled by the second node in a process relating to management of RAN resources controlled by the first node, or sending, to a third node in the RAN, a representation of the predicted resource status information describing usage of RAN resources controlled by the second node.

### TECHNICAL FIELD

The present disclosure relates to methods for managing radio resources in a Radio Access Network (RAN) of a communication network. The present disclosure also relates to a first, second and third nodes in a RAN, and to a computer program and a computer program product configured, when run on a computer to carry out methods for managing radio resources in a RAN of a communication network.

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the examples disclosed herein may be applied to any other example, wherever appropriate. Likewise, any advantage of any of the examples may apply to any other examples, and vice versa. Other objectives, features and advantages of the enclosed examples will be apparent from the following description.

The current 5G RAN (NG-RAN) architecture, as illustrated in FIG. 1, is depicted and described in TS 38.401 v15.4.0, available at: (http://www.3gpp.org/ftp//Specs/archive/38_series/38.401/38401-f40.zip). The NG architecture illustrated in FIG. 1 is described below.

The NG-RAN consists of a set of gNBs connected to the 5GC through the NG interface. A gNB can support FDD mode, TDD mode or dual mode operation. gNBs can be interconnected through the Xn interface. A gNB may consist of a gNB-CU and gNB-DUs. A gNB-CU and a gNB-DU are connected via the F1 logical interface. One gNB-DU is connected to only one gNB-CU. For resiliency, a gNB-DU may be connected to multiple gNB-CU by appropriate implementation. NG, Xn and F1 are logical interfaces. The NG-RAN is layered into a Radio Network Layer (RNL) and a Transport Network Layer (TNL). The NG-RAN architecture, i.e., the NG-RAN logical nodes, and interfaces between them, are defined as part of the RNL. For each NG-RAN interface (NG, Xn, F1) the related TNL protocol and the functionality are specified. The TNL provides services for user plane transport and signaling transport.

A gNB may also be connected to an LTE eNB via the X2 interface. Another architectural option is where an LTE eNB connected to the Evolved Packet Core network is connected over the X2 interface with a so called nr-gNB. The latter is a gNB not connected directly to a CN and connected via X2 to an eNB for the sole purpose of performing dual connectivity.

The architecture in FIG. 1 can be expanded by spitting the gNB-CU into two entities. One gNB-CU-UP, which serves the user plane and hosts the PDCP protocol, and one gNB-CU-CP, which serves the control plane and hosts the PDCP and RRC protocol. For completeness it should be noted that a gNB-DU hosts the RLC/MAC/PHY protocols.

### Resource Status Update

The XnAP and X2AP procedures are defined in 3GPP so that a RAN node can provide another RAN node with Resource Status Update related to different resources. The relevant procedures are:

In TS 36.423 v16.2.0 (X2AP):
Resource Status Reporting Initiation
Resource Status Reporting
EN-DC Resource Status Reporting Initiation
EN-DC Resource Status Reporting

### In TS 38.423 v16.2.0 (XnAP):

Resource Status Reporting Initiation
Resource Status Reporting

### Traffic Prediction—Cell Level

In the example illustrated in FIG. 2, a cell in a real network deployment predicts its future traffic in order to activate MIMO-sleep so as to save battery. FIG. 2 shows how the periodicity of traffic each day can enable an accurate prediction. The horizontal line shows the threshold for activation, the intermediate line is the prediction, while the line with the highest peaks shows the real data.

### Traffic Prediction—UE Level

With a prediction model, it is possible to estimate the probability of data arriving in the downlink and/or uplink. This could for example be the probability of data arriving within time T, or data received within the frame T1 to T2. The prediction could be based on the history of data transmissions/receptions of the UE (i.e. traffic pattern), UE behavior (e.g. activity and mobility pattern, etc.), or those of other UEs, for example by using any of the following inputs:
Packet Inter Arrival Time (standard deviation, average, median, . . . )
Number of Packets Up/Down
Total bytes Up/Down
Packet sizes
Time since last packet
Packet protocols (http/voice, . . . )
UE manufacturer
UE model and software version
PDU Session type(s)
QoS profile(s)
Slice type(s)

Current telecommunication systems have several ways to measure and report metrics that allow determination of resources consumed or available in a given area of coverage. Such metrics can be used for various purposes. In one example of current solutions, mobility load balancing decisions consider load metrics reflecting measurements taken in the past and reported from one (source) node to another (target) RAN node. One of the uses the target RAN node makes of such information is to decide which mobility target cell is the best possible handover target. There currently exist certain challenges, including supporting other uses that could be envisaged for information regarding resources used in a cell served by a neighbor RAN node.

### SUMMARY

It is an aim of the present disclosure to provide methods, first and third RAN nodes, and a computer readable medium which at least partially address one or more of the challenges discussed above. It is a further aim of the present disclosure to provide methods, first and third RAN nodes, and a computer readable medium which facilitate the management of radio resources within a RAN.

According to a first aspect of the present disclosure, there is provided a computer implemented method for managing resources in a Radio Access Network (RAN) of a communication network. The method, performed by a first node in the RAN, comprises obtaining a record of resource status information describing usage, during a historical time period, of RAN resources controlled by a second node in the RAN. The method further comprises predicting, based on the obtained record, resource status information describing usage of RAN resources controlled by the second node during a future time period. The method then comprises performing at least one of using the predicted resource status information describing usage of RAN resources controlled by the second node in a process relating to management of RAN resources controlled by the first node, or sending, to a third node in the RAN, a representation of the predicted resource status information describing usage of RAN resources controlled by the second node.

According to another aspect of the present disclosure, there is provided a computer implemented method for managing resources in a Radio Access Network (RAN) of a communication network. The method, performed by a third node in the RAN, comprises receiving, from a first node in the RAN, a representation of predicted resource status information describing usage of RAN resources controlled by a second node in the RAN during a future time period. The method further comprises using the predicted resource status information describing usage of RAN resources controlled by the second node in a process relating to management of RAN resources controlled by the third node.

According to another aspect of the present disclosure, there is provided a computer program product comprising a computer readable medium, the computer readable medium having computer readable code embodied therein, the computer readable code being configured such that, on execution by a suitable computer or processor, the computer or processor is caused to perform a method according to any one or more of aspects or examples of the present disclosure.

According to another aspect of the present disclosure, there is provided a first node in a communication network comprising a RAN, the first node being configured to manage resources in the Radio Access Network, RAN. The first node is configured to obtain a record of resource status information describing usage, during a historical time period, of RAN resources controlled by a second node in the RAN and to predict, based on the obtained record, resource status information describing usage of RAN resources controlled by the second node during a future time period. The first node is further configured to perform at least one of using the predicted resource status information describing usage of RAN resources controlled by the second node in a process relating to management of RAN resources controlled by the first node, or sending, to a third node in the RAN, a representation of the predicted resource status information describing usage of RAN resources controlled by the second node.

According to another aspect of the present disclosure, there is provided a third node in a communication network comprising a RAN, the third node being configured to manage resources in the Radio Access Network, RAN. The third node is configured to receive, from a first node in the RAN, a representation of predicted resource status information describing usage of RAN resources controlled by a second node in the RAN during a future time period, and to use the predicted resource status information describing usage of RAN resources controlled by the second node in a process relating to management of RAN resources controlled by the third node.

Examples of the present disclosure thus propose methods according to which a first RAN node may predict resource use, for example in the form of load metrics, of another network node. The predicted resource utilization can be used as input to processes for traffic steering and optimization such as load balancing or radio resource management. Examples of the present disclosure also propose signaling support for exchanging the predicted values of resource use between RAN nodes.

### BRIEF DESCRIPTION OF THE DRAWINGS

For a better understanding of the present disclosure, and to show more clearly how it may be carried into effect, reference will now be made, by way of example, to the following drawings in which:

FIG. 1 illustrates current 5G RAN (NG-RAN) architecture;

FIG. 2 illustrates predicted and actual traffic for a network cell;

FIG. 3 illustrates a part of a RAN comprising first, second and third network nodes;

FIG. 4 is a flow chart illustrating process steps in a method for managing resources in a RAN of a communication network;

FIG. 5 is a flow chart illustrating process steps in another example of a method for managing resources in a RAN of a communication network;

FIG. 6 is a message flow diagram illustrating an implementation of the methods disclosed herein;

FIGS. 7a-f show a flow chart illustrating process steps in another example of a method for managing resources in a RAN of a communication network;

FIGS. 8a-b show a flow chart illustrating process steps in another example of a method for managing resources in a RAN of a communication network;

FIGS. 9 to 18 are message flow diagrams illustrating example implementations of the methods disclosed herein;

FIGS. 19 and 20 are block diagrams illustrating functional modules in examples of a first node;

FIGS. 21 and 22 are block diagrams illustrating functional modules in examples of a third node;

FIG. 23 illustrates a wireless network in accordance with some examples;

FIG. 24 illustrates a User Equipment in accordance with some examples;

FIG. 25 illustrates a virtualization environment in accordance with some examples;

FIG. 26 illustrates a telecommunication network connected via an intermediate network to a host computer in accordance with some examples;

FIG. 27 illustrates a host computer communicating via a base station with a user equipment over a partially wireless connection in accordance with some examples;

FIG. 28 illustrates methods implemented in a communication system including a host computer, a base station and a user equipment in accordance with some examples;

FIG. 29 illustrates methods implemented in a communication system including a host computer, a base station and a user equipment in accordance with some examples;

FIG. 30 illustrates methods implemented in a communication system including a host computer, a base station and a user equipment in accordance with some examples; and

FIG. 31 illustrates methods implemented in a communication system including a host computer, a base station and a user equipment in accordance with some examples.

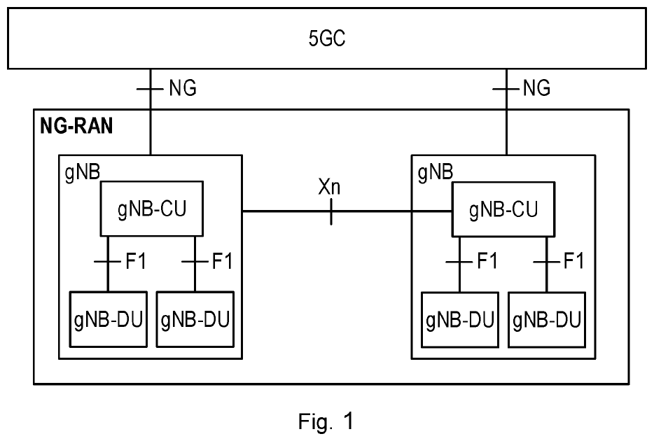

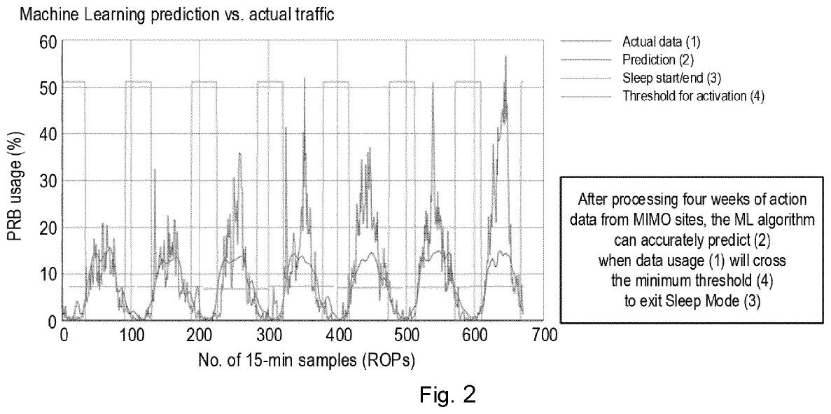

### DETAILED DESCRIPTION

As discussed above, there are many potential uses within a RAN for information about resource use at different RAN nodes. There may be additional use cases if the information encompassed a prediction of resources that will be used, for example for different radio carrier frequencies. There is generally a lack of support for the exchange of anticipated resource use metrics, which metrics could be input to several RAN processes, including load balancing, mobility and radio resource management.

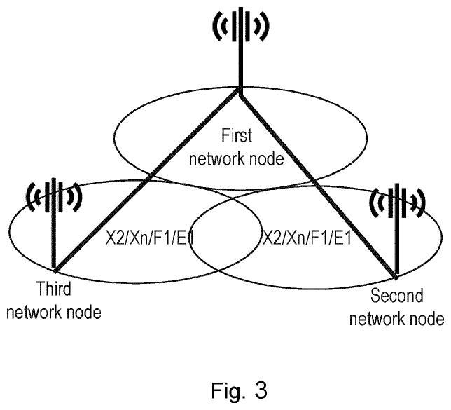

One case of interest is shown in FIG. 3, which illustrates a part of a RAN in which a first network node serves a first cell. For the purposes of the present disclosure, a “cell” refers to the geographic coverage area served by a Radio Access node of a communication network, and may also be used interchangeably to refer to the Radio Access node that serves the coverage area. The first cell neighbors a second cell served by a second network node and a third cell, served by a third network node. The second cell is also neighboring the third cell, but a direct signaling communication does not exist between the second network node and the third network node. One such deployment example is the case of two radio cells controlled by two different distributed units (DUs) of an NG-RAN node with split architecture. The two DUs have a direct commination interface with a centralized unit (CU), such as an F1 interface of the NG-RAN systems, but there may not be a direct communication interface between the two DUs. According to existing procedures, estimates or predictions of resource utilization related to the second network node cannot be made available at the third network node.

Examples of the present disclosure provide methods according to which a RAN node may estimate or predict resource utilization, for example in the form of load metrics, for another network node. The estimated or predicted resource use can be used as input to algorithms for traffic steering and optimization such as load balancing or radio resource management. Examples of the present disclosure also provide signaling support for exchanging the predicted values of resource use. The predicted values can be derived based on the actual and predicted status of resources in an given RAN node, and may also be derived based on the actual and predicted status of resources in other neighbor RAN nodes, and/or a history of load balancing decisions taken by the RAN node and its neighbor RAN nodes.

The predicted status of resource use can be obtained using rules based or other processes, using Artificial Intelligence or Machine Learning AI/ML algorithms and models found in literature, or by applying novel AI/ML algorithms and models. For the case illustrated in FIG. 3, estimates or prediction of resource utilization, such as load metrics, could be exchanged indirectly between the third node and the second node via the first node.

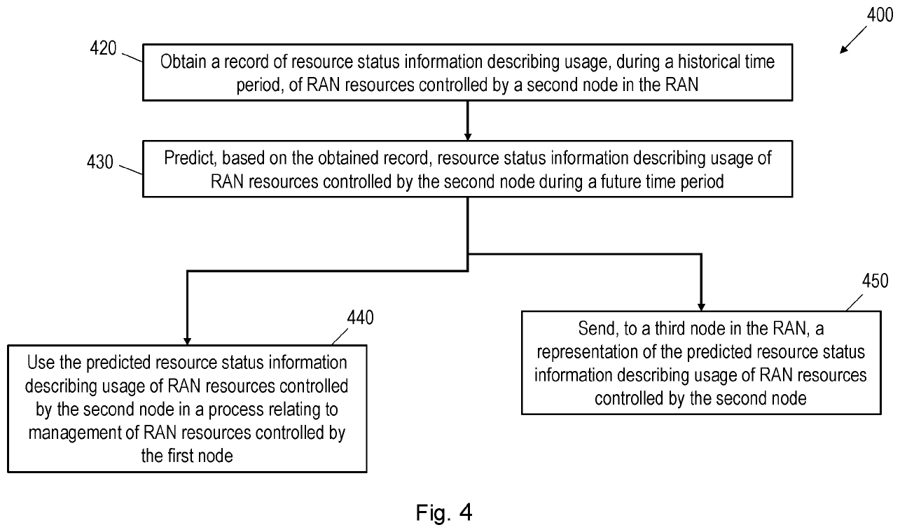

FIG. 4 is a flow chart illustrating process steps in a computer implemented method 400 for managing resources in a RAN of a communication network. The method, 400 is performed by a first node in the RAN. The first node may comprise a physical node and/or a virtualized network function operable to exchange wireless signals. In some examples, a Radio Access node may comprise a base station node such as a NodeB, eNodeB, gNodeB, or any other current or future implementation of this functionality. Additional discussion of a wireless network, network nodes, UEs, etc. is provided at the end of the present description.

Referring to FIG. 4, the method 400 comprises, in a first step 420, obtaining a record of resource status information describing usage, during a historical time period, of RAN resources controlled by a second node in the RAN. The method then comprises, in step 430, predicting, based on the obtained record, resource status information describing usage of RAN resources controlled by the second node during a future time period. The method 400 then comprises performing at least one of steps 440 and/or 450. In step 440, the method 400 comprises using the predicted resource status information describing usage of RAN resources controlled by the second node in a process relating to management of RAN resources controlled by the first node. In step 450, the method 400 comprises sending, to a third node in the RAN, a representation of the predicted resource status information describing usage of RAN resources controlled by the second node.

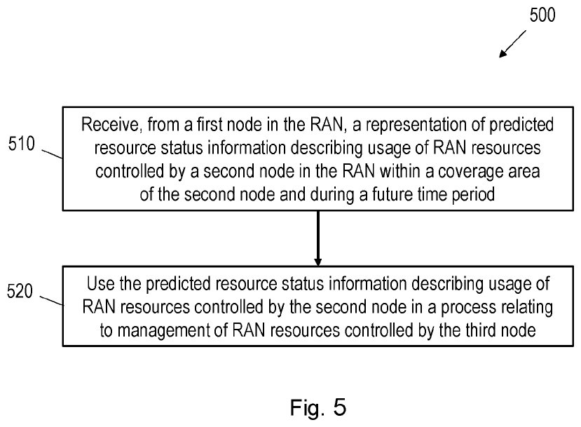

The method 400 of FIG. 4 may be complimented by a method 500, performed by a third node in the RAN. FIG. 5 is a flow chart illustrating process steps in a computer implemented method 500 for managing radio resources in a RAN of the communication network. As for the first node, the third node may comprise a physical node and/or a virtualized network function operable to exchange wireless signals. In some examples, a Radio Access node may comprise a base station node such as a NodeB, eNodeB, gNodeB, or any other current or future implementation of this functionality.

Referring to FIG. 5, the method 500 comprises, in a first step 510, receiving, from a first node in the RAN, a representation of predicted resource status information describing usage of RAN resources controlled by a second node in the RAN during a future time period. The method then comprises, in step 520, using the predicted resource status information describing usage of RAN resources controlled by the second node in a process relating to management of RAN resources controlled by the third node.

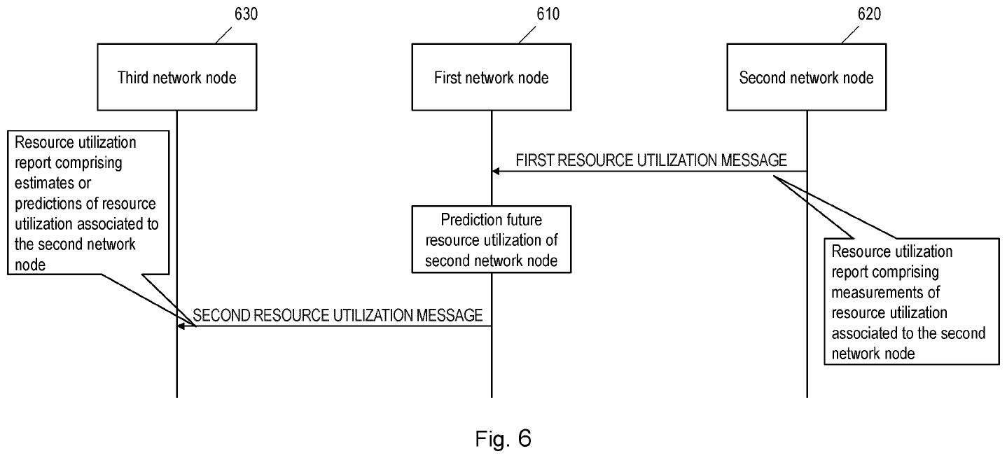

In some examples of the present disclosure, obtaining a record of resource status information from the second node, and sending a representation of predicted resource statis information to the third node, may be accomplished through the receiving and sending of resource utilization messages. One example implementation of the methods 400, 500 is illustrated in the message flow diagram of FIG. 6. Referring to FIG. 6, the first node 610 receives a FIRST RESOURCE UTILIZATION message from the second network node 620, the message comprising an indication of the current resource utilization of the second network node (step 120). The first node 610 then determines an estimate or prediction of future resource utilization for at least one load metric of the second network node (step 130). The first node may then optimize mobility related events between the first and the second network nodes, such as for handover or traffic steering to/from the second network node, based on the estimated or predicted resource utilization for at least one load metric of the second network node (step 140). Additionally or alternatively, the first node may also transmit a SECOND RESOURCE UTILIZATION message to a third network node 630, the second message comprising at least one estimate or prediction of the future resource utilization for at least one load metric associated with the second network node. It will be appreciated that the third network node 630 may or may not be a neighbor of the second network node. The first and second RESOURCE UTILIZATION message could be, in one possible implementation, RESOURCE STATUS UPDATE messages of the 3GPP LTE or NR systems.

Different examples of the present disclosure may vary the type and granularity of load metrics associated with the second network node that are estimated or predicted by the first network node on the basis of the resource status information, for example received measurements or resource utilization, of the second network node.

In one example, the first network node transmits a FIRST RESOURCE UTILIZATION REQUEST message to the second network node. The FIRST RESOURCE UTILIZATION REQUEST may for example be a RESOURCE STATUS REQUEST message defined in the 3GPP LTE and NR systems. The FIRST RESOURCE UTILIZATION REQIEST message may trigger the second network node to provide the resource status information obtained by the first network node in step 120 of the method 100.

In one example, the first node may collect measures of its own and other network node utilized resources in addition to resource status information for the second node, and may provide such measures, for example together with other information available at the node, as input to an algorithm or process that predicts the resources utilized by the second network node in a future time window. Such resource utilization prediction may be derived for different parts of the system, for example for the radio interface, for the transport network, for specific cells or beamformed coverage areas, for specific classes of services or network slices.

The first network node may further receive a SECOND RESOURCE UTILIZATION REQUEST message from the third network node, comprising a request for resource utilization associated with the second network node. In one possible implementation, the SECOND RESOURCE UTILIZATION REQUEST is a RESOURCE STATUS REQUEST message defined in the 3GPP LTE and NR systems.

In another example, the SECOND RESOURCE UTILIZATION REQUEST message from the third network node may comprise a list of cells served by the second network node. The list of cells may have been received by the third network node from the first network node (e.g. as part of “Neighbor Information NR” IE or “Neighbor Information E-UTRA” IE in XnAP XN SETUP REQUEST message). The list of cells may include cells served by the second network node for which the third node is interested to receive predicted load metrics information and/or measured load metrics. Non limiting examples of reasons for such an interest are:
A change in specific conditions of the cells of the second node makes them suitable for a new load balancing scenario (e.g. the connectivity support for EN-DC is changed from not-supported to supported).
The third node initiates the request upon change of specific conditions related to the third network node as a whole or to at least one of the cells served by the third network node.
The cells in question are neighboring at least one cell served by the third node.

In one example, the first network node may send the FIRST RESOURCE UTILIZATION REQUEST message to the second node in response to receiving the SECOND RESOURCE UTILIZATION REQUEST message from the third node. The first node may then forward information about the predicted use of resources by the second node to the third node, for example in response to the SECOND RESOURCE UTILIZATION REQUEST message. The third node may use this information for a number of purposes.

In one example, the third node receiving the prediction of resource utilization associated with the second network node may use it to optimize its traffic steering and radio resource management functions, e.g. mobility related decisions. For example, on the basis of a predicted load for a given future time window, the third network node may determine which of the potential handover target cells of the second network node may be the optimal to serve a moving UE and select the determined cell as target.

In another example, the third network node receiving the prediction of resource utilization associated with the second network node may use it to estimate the level of cross cell interference caused by communication on the utilized resources of neighboring cells of the second network node. This may assist the third network node in taking decisions on resource utilization or on configuration of radio channels that are affected by the resource utilization of the second network node.

Example methods of the present disclosure thus provide a process according to which a third network node may consider the predicted status of resources of a second network node, with which the first network node may have no direct signaling connection, as input for its traffic steering and radio resource management functions. The predicted status may be generated by a first network node having a direct signaling connection with each of the third and second network nodes. This provision of predicted resource status may have considerable advantages for the smooth execution and resource optimization of operations involving one, or more of the nodes. For example, a mobility related decision can be taken to move UEs between the first network node towards the second network node via indirect signaling. Traffic steering and radio resource management functions of the third network node can consequently be improved using inputs including prediction of resources used by the second network node, obtained via a first network node.

Some of the example methods and nodes contemplated herein will now be described more fully with reference to the accompanying drawings. Other examples, however, are contained within the scope of the subject matter disclosed herein, the disclosed subject matter should not be construed as limited to only the examples set forth herein; rather, these embodiments are provided by way of example to convey the scope of the subject matter to those skilled in the art.

It will be appreciated that for the purposes of the present disclosure, a node of a Radio Access Network (RAN), also referred to herein as a RAN node, comprises a node that is operable to transmit, receive, process and/or orchestrate wireless signals. A RAN node may comprise a physical node and/or a virtualized network function.

The term RAN node may therefore refer to Long Term Evolution (LTE) or New Radio (NR) technology and may be one of eNB, gNB, en-gNB, ng-eNB, CU-CP, CU-UP, DU, gNB-CU, gNB-DU, gNB-CU-UP, gNB-CU-CP, eNB-CU, eNB-DU, eNB-CU-UP, eNB-CU-CP, IAB-node, IAB-donor DU, IAB-donor-CU, IAB-DU, IAB-MT, O-CU, O-CU-CP, O-CU-UP, O-DU, O-RU, O-eNB, or any future implementation of the above discussed functionality.

Also for the purposes of the present specification, the term RAN resources refers to any resources available to the RAN network, and under the control of one or more nodes of the RAN network. Such resources may include radio spectrum resources, examples of which include PRBs in downlink and uplink, PDCCH CCEs for downlink and uplink and other examples, such as are reported in TS38.423 for the IE Radio Resource Status. A coverage area of a RAN node refers to the geographical and/or radio area over which the RAN node provides access to the communication network.

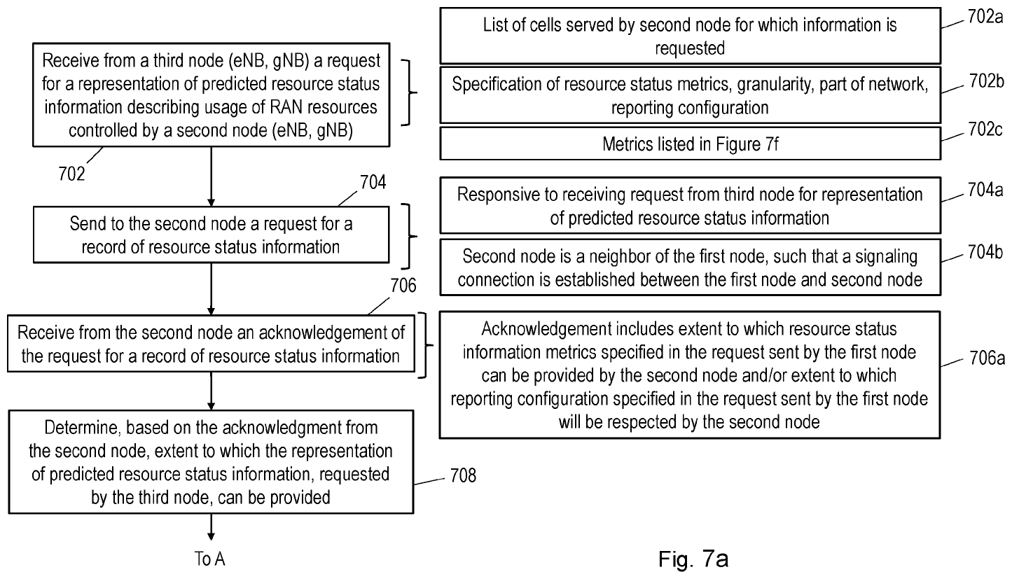

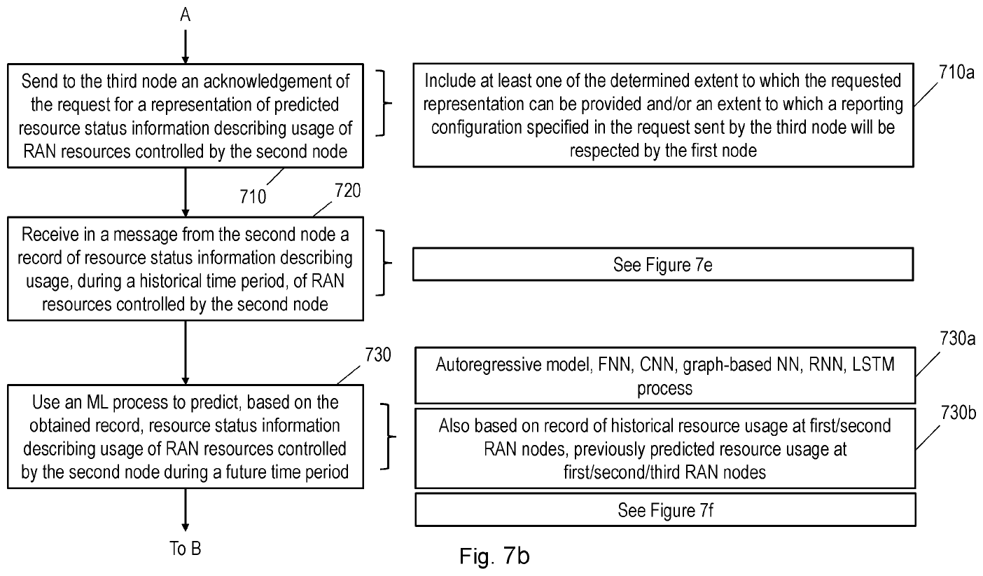

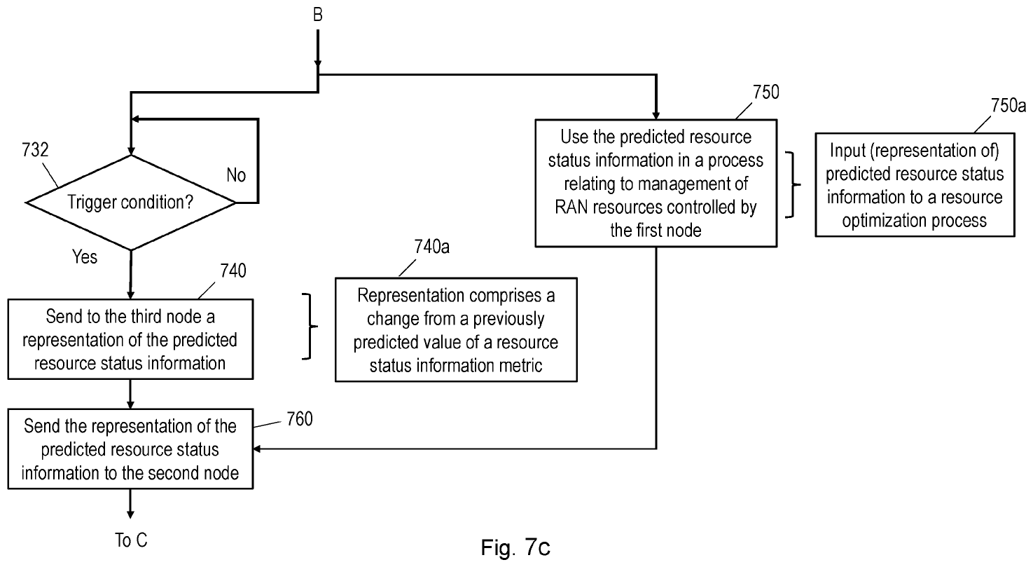

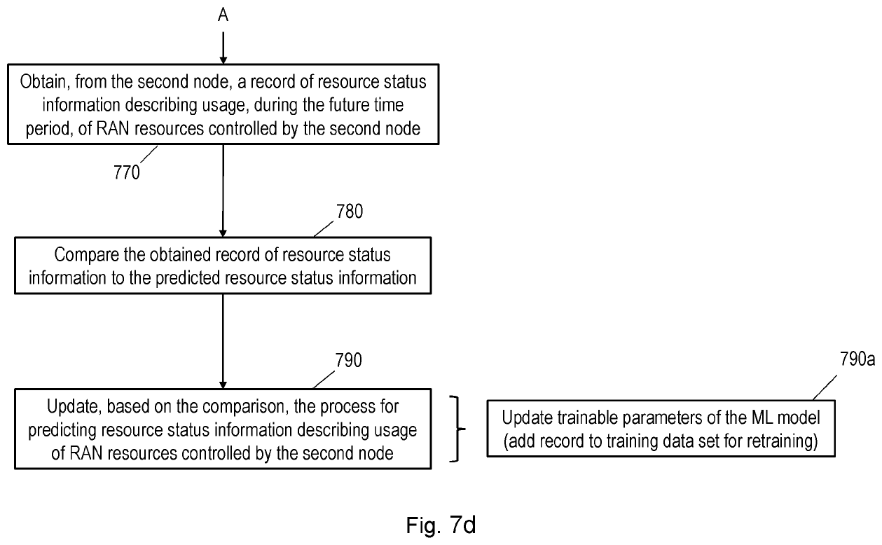

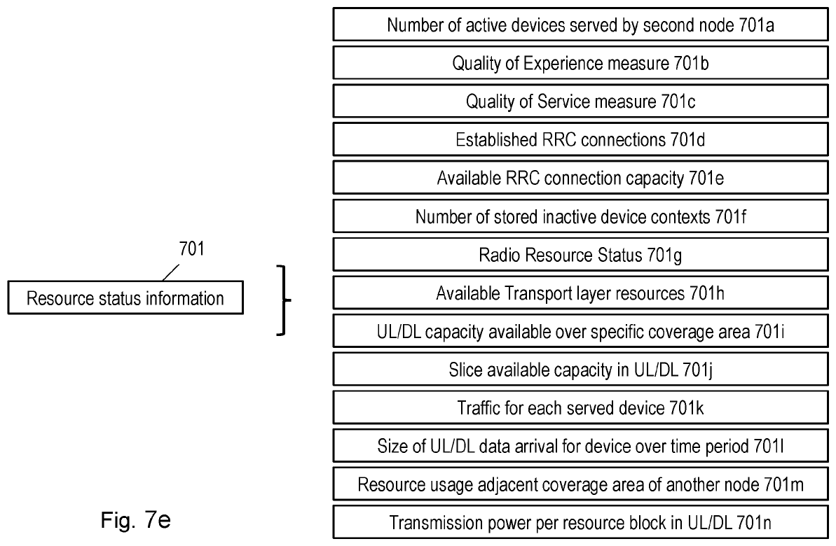

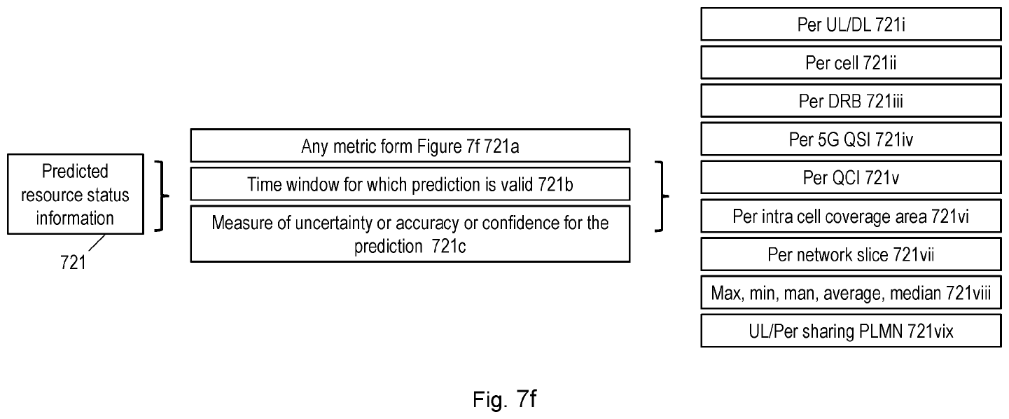

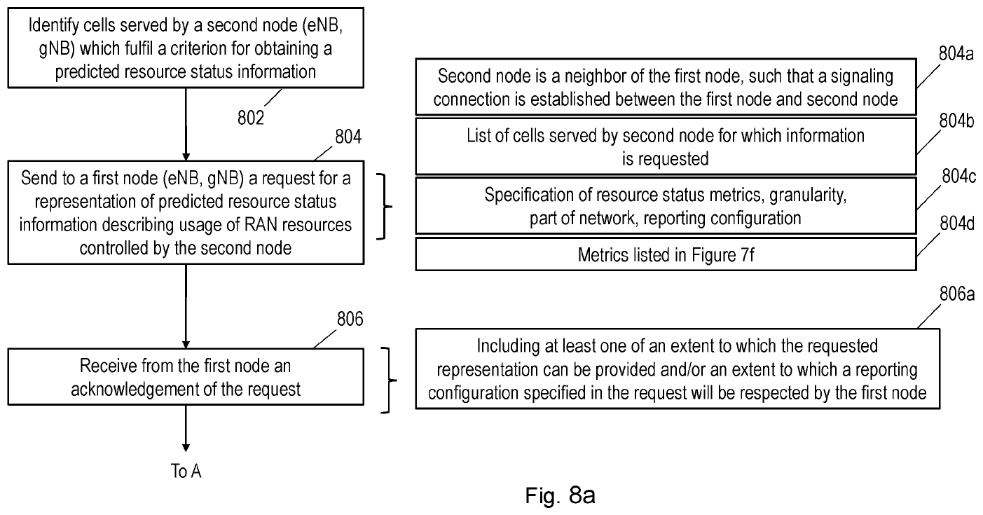

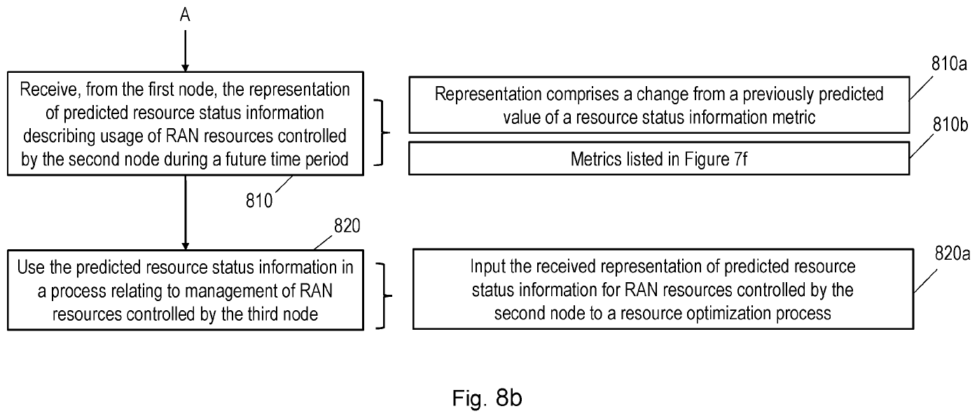

FIGS. 7a to 7f show a flow chart illustrating process steps in another example of computer implemented method 700 for managing resources in a RAN of a communication network. The method 700 provides one example of how the steps of the method 400 may be implemented and supplemented to achieve the above discussed and additional functionality. As for the method 400 discussed above, the method 700 is carried out by a first node in the RAN. The first node may comprise a physical node and/or a virtualized network function operable to exchange wireless signals. In some examples, the first node may comprise a base station node such as a NodeB, eNodeB, gNodeB, or any other current or future implementation of this functionality.

Referring first to FIG. 7a, in step 702 the first node may receive from a third node in the RAN a request for a representation of predicted resource status information describing usage of RAN resources controlled by a second node in the RAN. At least one of the first, second or third nodes may comprise at least one of an eNB; ng-eNB; eNB-CU; eNB-DU; eNB-CU-UP; eNB-CU-CP; gNB; en-gNB; gNB-CU; gNB-DU; gNB-CU-UP; and/or gNB-CU-CP. The request for a representation of predicted resource status information may in some examples comprise a modified Resource Status Request message as defined in LTE and 5G systems.

As illustrated at 702a the request for a representation of predicted resource status information describing usage of RAN resources controlled by the second node may comprise a list of cells served by the second node and for which prediction of resource status information metrics is requested. The list may have been received from the first node, for example as part of a neighbor relation procedure. The request for a representation of predicted resource status information may comprise a modified Resource Status Request message, or any other newly specified or existing message suitable for conveying the request.

As illustrated at 702b, the request for a representation of predicted resource status information describing usage of RAN resources controlled by the second node may also or alternatively comprise at least one of a specification of resource status information metrics to be predicted, a requested granularity of prediction, a part of the communication network for which prediction is requested, and/or a reporting configuration for providing the requested representation. The part of the network could be a plurality of cells, a radio interface, network slice, or may correspond to any of the criteria illustrated at 721i to 721vix of FIG. 7f (described below). In one example, the request for a representation of predicted resource status information describing usage of RAN resources controlled by the second node may comprise a SECOND RESOURCE UTILIZATION REQUEST message, and may comprise elements described below in connection with that message.

The specification of resource status information metrics to be predicted comprise any one or more of the metrics listed in FIG. 7e or 7f (described below). The requested granularity of prediction may comprise any one or more of the criteria listed in FIG. 7f (described below).

Referring still to FIG. 7a, in step 704 the first node sends to the second node a request for a record of resource status information. The request may comprise a Resource Status Request message of LTE or 5G procedures, or may comprise a different message, which may be specific to the purpose of requesting a record of resource status information from the second node, may be part of a newly specified signaling architecture or may be an adapted or augmented version of a different existing message of LTE or 5G procedures. As illustrated at 704a, the sending to the second node of the request for the record of resource status information at step 704 may be responsive to receiving from the third node in step 702 the request for a representation of predicted resource status information describing usage of RAN resources controlled by the second node. In other examples, the first node may initiate the sending of the request in step 704 without first receiving the request from the third node in step 702.

As illustrated at 704b, the second node may be a neighbor of the first node, such that a signaling connection is established between the first node and second node. The third node may or may not be a neighbor of the second node, and a signaling connection may or may not be established and/or functional between the third and second nodes.

In step 706, the first node receives from the second node an acknowledgment of the request sent in step 704. In some examples, the acknowledgement may comprise a Resource Status Response message, or any other newly specified or existing message suitable for conveying the acknowledgement. As illustrated at 706a, the acknowledgement may indicate at least one of an extent to which resource status information metrics specified in the request sent by the first node can be provided by the second node, and/or an extent to which a reporting configuration specified in the request sent by the first node will be respected by the second node. The extent to which the requested information can be provided could be all of the requested information, some of the requested information, or none of the requested information, in which case the acknowledgement may comprise a failure message.

If the first node performed step 702 of receiving a request for status information from the third node, the first node may then, at step 708, determine based on the acknowledgment received from the second node an extent to which the representation of predicted resource status information requested by the third node can be provided.

Referring now to FIG. 7b, the first node may then in step 710 send to the third node an acknowledgement of the request for a representation of predicted resource status information describing usage of RAN resources controlled by the second node. The acknowledgement could be a modified Resource Status Response message, or any other newly specified or existing message suitable for conveying the acknowledgement.

As illustrated at 710a, the first node may include in the acknowledgement to the third node at least one of (i) the determined extent to which the representation of predicted resource status information describing usage of RAN resources controlled by the second node, requested by the third node, can be provided, and/or (2) an extent to which a reporting configuration specified in the request sent by the third node will be respected by the first node.

In step 720, the first node receives in a message from the second node a record of resource status information describing usage, during a historical time period, of RAN resources controlled by the second node. FIG. 7e illustrates the metrics that may be included in the record of resource status information (701) received at step 720.

Referring now to FIG. 7e, these metrics include:
number of active wireless devices served by the second node (701a);
Quality of Experience measure (701b);
Quality of Service measure (701c);
established Radio Resource Control, RRC, Connections (701d);
available RRC Connection capacity (701e);
number of inactive UE contexts for wireless devices stored by the second node (701f);
Radio Resource Status (701g);
available Transport Network Layer resources (701h);
capacity available over a specific radio coverage area of the second node, in uplink and/or downlink (701i);
Slice Available Capacity, in uplink and/or downlink (701j);
traffic for each served wireless device (701k);
size of data arrival in uplink or downlink for a wireless device within a time period (7011);
resource use in a part of the coverage area of the second node that is adjacent a coverage area of another node (701m); and/or
transmission power used per resource block in uplink and/or downlink (701n).

Further discussion of the above metrics is provided in later sections of the present disclosure. The record of resource status information could be included in a Resource Status Response message, or any other newly specified or existing message suitable for conveying examples of the above discussed resource utilization metrics.

Referring again to FIG. 7b, in step 730, the first node uses a Machine Learning (ML) model to predict, based on the obtained record, resource status information describing usage of RAN resources controlled by the second node during a future time period. As illustrated at 730a, this may comprise using at least one of an Autoregressive model, a Feedforward Neural Network, a Convolutional Neural Network, a graph-based Neural Network, a Recurrent Neural Network and/or a Long Short-Term Memory process to predict the resource status information.

As discussed above, while the example method 700 uses an ML model to predict resource status information for the second node during a future time period, other prediction processes, such as rule-based processes, may be envisaged for this step.

As illustrated at 730b, the prediction may also be based on at least one of:
(1) a record of resource status information describing usage, during a historical time period, of RAN resources controlled by the first node;
(2) a record of resource status information describing usage, during a historical time period, of RAN resources controlled by the third node;
(3) previously predicted resource status information describing usage of RAN resources controlled by the first node during a future or historical time period;
(4) previously predicted resource status information describing usage of RAN resources controlled by the second node during a future or historical time period;
(5) previously predicted resource status information describing usage of RAN resources controlled by the third node during a future or historical time period.

The previously predicted information may comprise predictions generated by the first node or obtained predictions, for example received from the second or third nodes.

FIG. 7f illustrates examples of what may be included in the predicted resource status information. Referring to FIG. 7f, the predicted resource status information (721) describing predicted usage of RAN resources controlled by the second node may comprise at least one of:
any one or more of the metrics illustrated in FIG. 7e (721a);
a time window for which the predicted resource status information is valid (721b); and/or
a measure of uncertainty and/or accuracy and/or confidence interval for the predicted resource status information (721c).

The measure of uncertainty may be per predicted matric or a global measure for the prediction.

As illustrated in FIG. 7f, the resource status information and predicted resource status information may be assembled (that is they may be obtained, for the resource status information, and/or predicted, for the predicted resource status information) with a granularity according to at least one of the criteria:
per uplink/downlink (721i);
per cell (721ii);
per Data Radio Bearer (721iii);
per 5G Quality of Service Indicator (721iv);
per Quality of Service Class Indicator (721v);
per intra cell coverage area (721vi);
per network slice (721vii);
maximum, minimum, mean, average, median (721viii); and/or
per sharing PLMN (721vix).

Referring now to FIG. 7c, following predicting of resource status information describing usage of RAN resources controlled by the second node during a future time period, the first node may use the predicted information in step 750 and may alternatively or additionally send a representation of the predicted information to the third node in step 740.

In step 750, the first node uses the predicted resource status information describing usage of RAN resources controlled by the second node in a process relating to management of RAN resources controlled by the first node. As illustrated at 750a, this may comprise inputting the received representation of predicted resource status information for RAN resources controlled by the second node to a resource optimization process. The resource optimization process may relate to load balancing, mobility events, or other resource management procedures, including for example handover, traffic steering to/from the second node, etc.

In step 732, if the first node is to send a representation of the predicted information to the third node, the first node checks for fulfillment of a trigger condition, which may comprise at least one of a timer or a threshold for a predicted metric. The trigger condition may for example have been specified in a request received from the third node in step 702. In step 740, on fulfillment of the trigger condition, the first node sends to the third node, a representation of the predicted resource status information describing usage of RAN resources controlled by the second node. As illustrated at 740a, the representation of the predicted resource status information describing usage of RAN resources controlled by the second node may comprise a change from a previously predicted value of a resource status information metric. The representation of the predicted resource status information could be included in a modified Resource Status Response message, or any other newly specified or existing message suitable for conveying the representation. In one example, the representation of the predicted resource status information could be included in a SECOND RESOURCE UTILIZATION MESSAGE, and may comprise elements described below in connection with that message.

In step 760, the first node may in some examples send the representation of the predicted resource status information describing usage of RAN resources controlled by the second node to the second node.

Referring now to FIG. 7d, in step 770 the first node obtains, from the second node, a record of resource status information describing usage, during the future time period, of RAN resources controlled by the second node. The first node then compares the obtained record of resource status information to the predicted resource status information in step 780, and may in step 790 update, based on the comparison, a process for predicting resource status information describing usage of RAN resources controlled by the second node. If the process for predicting resource status information comprises an ML process, updating the process may for example comprise updating trainable parameters of an ML model. Updating may comprise adding the obtained record to a training data set and updating the trainable parameters of the ML model when the training data set or model performance fulfil a condition for re-training.

FIGS. 8a and 8b show a flow chart illustrating process steps in another example of computer implemented method 800 for managing resources in a RAN of a communication network. The method 800 provides one example of how the steps of the method 500 may be implemented and supplemented to achieve the above discussed and additional functionality. As for the method 500 discussed above, the method 800 is carried out by a third node in the RAN. The third node may comprise a physical node and/or a virtualized network function operable to exchange wireless signals. In some examples, the third node may comprise a base station node such as a NodeB, eNodeB, gNodeB, or any other current or future implementation of this functionality.

Referring first to FIG. 8a, in step 802 the third node may identify cells served by a second node in the RAN which fulfil a criterion for obtaining a predicted resource status information. Possible criteria are discussed briefly above and include:
a change in specific conditions of the cells of the second node that makes them suitable for a new load balancing scenario (e.g. the connectivity support for EN-DC is changed from not-supported to supported);
a change of specific conditions related to the third network node as a whole or to at least one of the cells served by the third network node;
the cells in question being neighbors of at least one cell served by the third node.

In step 804, the third node may send to a first node in the RAN a request for the representation of predicted resource status information describing usage of RAN resources controlled by the second node. As illustrated at 802 and 804, at least one of the first, second or third nodes may comprise at least one of an eNB; ng-eNB; eNB-CU; eNB-DU; eNB-CU-UP; eNB-CU-CP; gNB; en-gNB; gNB-CU; gNB-DU; gNB-CU-UP; and/or gNB-CU-CP. The request for a representation of predicted resource status information may in some examples comprise a modified Resource Status Request message as defined in LTE and 5G systems.

As illustrated at 804a, the second node may be a neighbor of the first node, such that a signaling connection is established between the first node and second node. The third node may or may not be a neighbor of the second node, and a signaling connection may or may not be established and/or functioning between the third and second nodes.

As illustrated at 804b, the request for a representation of predicted resource status information describing usage of RAN resources controlled by the second node may comprise a list of cells served by the second node and for which prediction of resource status information metrics is requested. The list may have been received from the first node, for example as part of a neighbor relation procedure. The request for a representation of predicted resource status information may comprise a modified Resource Status Request message, or any other newly specified or existing message suitable for conveying the request.

As illustrated at 804c, the request for a representation of predicted resource status information describing usage of RAN resources controlled by the second node may also or alternatively comprise at least one of a specification of resource status information metrics to be predicted, a requested granularity of prediction, a part of the communication network for which prediction is requested, and/or a reporting configuration for providing the requested representation. The part of the network could be a plurality of cells, a radio interface, network slice, or may correspond to any of the criteria illustrated at 721i to 721vix of FIG. 7f (described above).

The specification of resource status information metrics to be predicted comprise any one or more of the metrics listed in FIG. 7e or 7f (described above). The requested granularity of prediction may comprise any one or more of the criteria listed in FIG. 7f (described above).

In step 806, the third node may receive from the first node an acknowledgement of the request for a representation of predicted resource status information describing usage of RAN resources controlled by the second node. The acknowledgement may for example be a modified Resource Status Response message, or any other newly specified or existing message suitable for conveying the acknowledgement. As illustrated at 806a, the acknowledgement may include at least one of (1) an extent to which the representation of predicted resource status information describing usage of RAN resources controlled by the second node, requested by the third node, can be provided by the first node, and/or (2) an extent to which a reporting configuration specified in the request sent by the third node will be respected by the first node.

Referring now to FIG. 8b, in step 810 the third node receives, from the first node, a representation of predicted resource status information describing usage of RAN resources controlled by the second node during a future time period. As illustrated at 810a, the representation may in some examples comprise a change from a previously predicted value of a resource status information metric. The predicted resource status information may comprise any one or more of the metrics listed in FIG. 7e or 7f (described above). The representation of predicted resource status information may be provided in a modified Resource Status Response message, or any other newly specified or existing message suitable for conveying the representation.

In step 820, the third node uses the predicted resource status information describing usage of RAN resources controlled by the second node in a process relating to management of RAN resources controlled by the third node. As illustrated at 820a, this may comprise inputting the received representation of predicted resource status information for RAN resources controlled by the second node to a resource optimization process. The resource optimization process may relate to load balancing, mobility events, or other resource management procedures, including for example handover, traffic steering to/from the second node, etc.

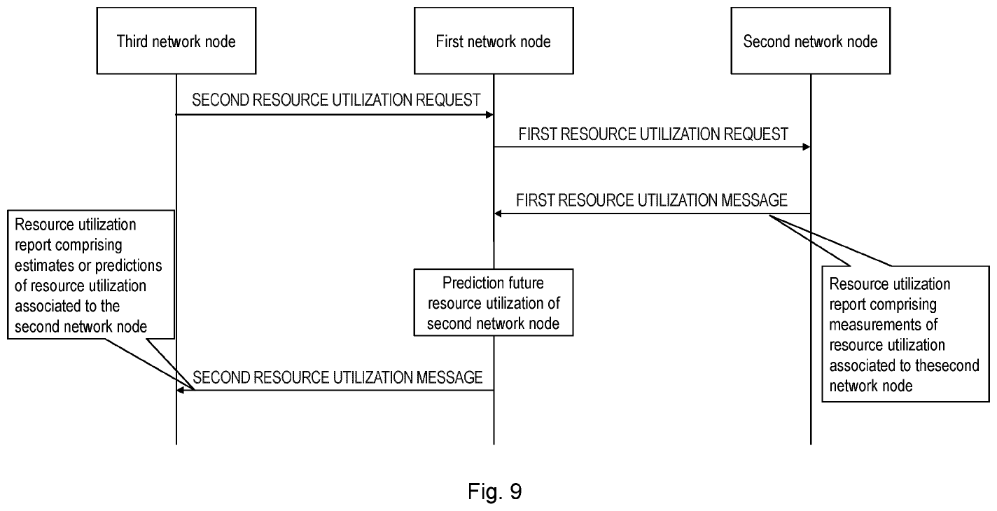

FIGS. 4, 5, 7a-f, and 8a-b discussed above provide an overview of methods which may be performed according to different examples of the present disclosure. The methods involve a first node in a RAN obtaining a record of resource status information for a second node in the RAN. The first node uses the record to predict resource usage for the second node in a future time period, and may use this prediction it its own resource optimization procedures, and may also or alternatively provide a representation of the prediction to a third node in the RAN. In this manner, predicted resource usage at different RAN nodes may be provided to other RAN nodes, so allowing such nodes to take this predicted usage into account in their own resource optimization procedures, resulting in improved overall resource management. There now follows a detailed discussion of how different process steps illustrated in FIGS. 4, 5, 7a-f, and 8a-b, and discussed above may be implemented, using example message flows according to the present disclosure and referring to FIGS. 9 to 18.

In the following example implementations, methods in accordance with the present disclosure are executed in a RAN in which a first RAN node is neighboring a second RAN node and a third RAN node. A signaling connection is established between the first network node and the second network node, and between the first network node and the third network node. The cells served by the second RAN node may provide coverage for a geographical area that is adjacent to the coverage provided by the cells served by the third RAN node. In some examples, there may also exist a direct signaling connection (e.g. via XnAP or X2AP) between the second RAN node and the third RAN node.

Implementation relating to the first network node (methods 400, 700)

According to a first example implementation, the first network node:
Receives a FIRST RESOURCE UTILIZATION message from the second network node comprising an indication of the current resource utilization of the second network node; and
Determines an estimate or a prediction of future resource utilization for at least one load metric of the second network node.

The FIRST RESOURCE UTILIZATION message received from the second network node comprises actual resource utilization information of the second network node, i.e. measurements of actual resource utilization performed by the second network node in previous measurement intervals. As such, this information can be obtained by the first network node via legacy methods, such as the RESOURCE STATUS REPORTING procedure of 3GPP LTE and NR systems. The first network node may determine an estimate or a prediction of the resource status or resource utilization associated with the second RAN node for future time instances based on the actual resource status or resource utilization information during past time instances. The first network node may adopt, for instance, machine learning and/or artificial intelligence (ML/AI) techniques to estimate and/or predict the future resource utilization of the second network node. The measurements received with the FIRST RESOURCE UTILIZATION message may provide a reference for the accuracy of the estimate performed in previous time instances.

In one example, the first network node uses the estimated or predicted resource utilization in neighboring coverage areas, such as neighboring cells, controlled by a second network node, to make improved mobility decisions, such as for handover or traffic steering to/from the second RAN node. In one example, the first network node may use the estimated or predicted (future) resource utilization associated for the second network node, in addition to or as a replacement for the resource utilization reported by the second network node for previous time instances, to deduce how much traffic can be handed over to the second network node coverage area, and therefore how much resource will be available in the coverage area provided by cells served by the first network node and by cells served by the second network node. In another example, the first network node may use its prediction of the future resource utilization associated with the second network node to deduce how much interference the second network node may cause to radio communications between the first network node and UEs camped on or served by cells served by first network node. This in turn provides an indication of how much resource the first network node needs to serve its UEs, for example with higher interference from neighbor cells, lower modulation and coding schemes may need to be selected and therefore less spectral efficiency is achieved.

In one example, the first network node may use the estimated or predicted resource utilization in neighboring coverage areas, such as neighboring cells, controlled by a second network node to assist mobility optimization decisions of a third network node. In this case, the first network node may additionally:
Transmit a SECOND RESOURCE UTILIZATION message to a third network node, the second message comprising at least one estimate or prediction of the future resource utilization for at least one load metric associated with the second network node. This has the advantage of enabling the third network node to optimize mobility decisions for its radio cells that are neighboring other radio cells controlled by the second network node.

Scenarios that may benefit from the first network node sending the prediction to the third network node include:
(1) A network deployment in which a direct communication interface does not exist between the third and the second network node. One example is the case in which the first, the second and the third network nodes belong to different communication systems. For instance, the first network node may belong to system 1 and have a connection to a second network node in system 2. Another example is where the first, the second and the third network nodes belong to the same communication system, and the task to establish a direct communication between the third and the second network nodes is left to automated functions that have not yet completing this task, or to a manual task which has not been executed yet. Another example is where the first, the second and the third network nodes belong to the same communication system, a standardized interface exists between the first network node and the second network node, and between the first network node and the third network node, but no standard interface exists the second network node and the third network node. For example, the first network node may be a gNB-CU-CP, and the second and third nodes may be gNB-DUs controlled by the first network node.
(2) A network deployment in which a direct communication interface between the third and the second network node exists but it is temporarily not available, for example out of service for maintenance reasons, or a scenario in which the third network node does not have the capabilities to make predictions or estimates of future resource utilization in another network node. For example, the first network node may be a gNB-CU, whilst the third network node may be a gNB-DU.

In one example, the first network node additionally:
Receive from the third network node a request to receive predictions of resource utilization associated with the second node.

A RESOURCE UTILIZATION REQUEST from the third node to the first node could be implemented, for example, with enhancements to existing signaling procedures such as a RESOURCE STATUS REQUEST of the 3GPP LTE and NR systems, as illustrated in 9. The received request may specify which type of resource utilization metrics should be estimated/predicted, with what granularity (for example in the frequency domain, time domain or spatial domain, coverage beam, slice), the reporting mechanism (for example periodic or aperiodic reporting, reporting resources).

FIG. 9 illustrates signaling steps for initiating a reporting procedure from the first network node to the third network node of estimates/predictions of resource utilization associated with the second network node. Referring to FIG. 9, upon receiving from the third RAN node a request to receive predictions of resource utilization associated with the second network node, the first node may additionally trigger/initialize a resource utilization reporting procedure with the second network node to collect measurements that would be used for estimating/predicting future resource utilization of the second network node. In one example illustrated in FIG. 9, the first network node may additionally
Transmit a first request for resource utilization measurements and/or for prediction of resource utilization measurements to the second node based on the second request of actual and/or predictions measurement received from the third RAN node.

In the illustrated example, the FIRST RESOURCE UTILIZATION REQUEST could be implemented with existing signaling procedure such as a RESOURCE STATUS REQUEST of the 3GPP LTE and NR systems as illustrated in FIG. 9. The content of the FIRST RESOURCE UTILIZATION REQUEST message transmitted by the first network node to the second network node can be determined based on the content of the SECOND RESOURCE UTILIZATION REQUEST message received by the first network node from the third network node. Additionally, the transmitted request may specify which type of resource utilization metrics should be estimated/predicted, with what granularity (for example in frequency domain, time domain or spatial domain, coverage beam, slice), the reporting mechanism (for example periodic or aperiodic reporting, reporting resources). It will be appreciated that the names first/second message, in this case, do not refer to any specific chronological order. Rather the first resource utilization exchange of request and response messages takes place between the first node and the second node, and the second resource utilization exchange of request and response messages takes place between the first node and the third node.

### Signaling Successful Operation

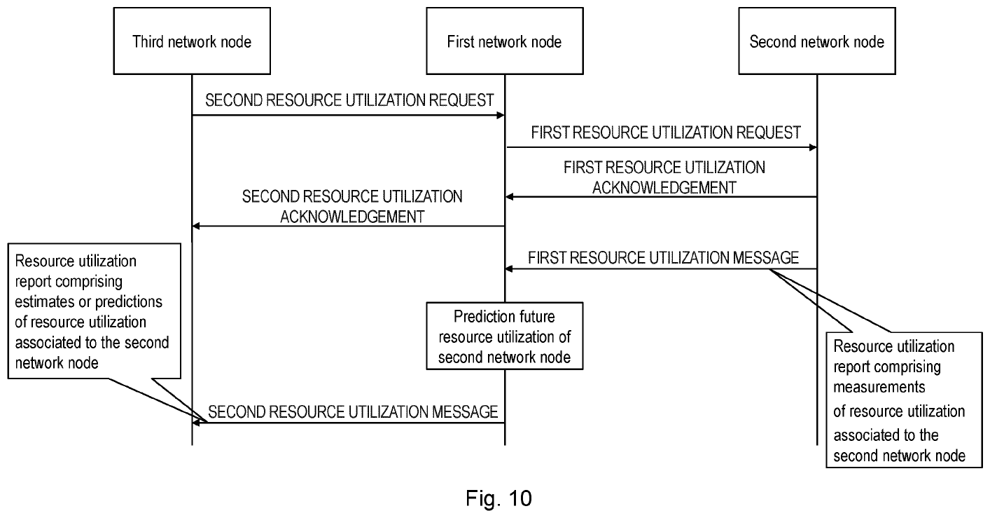

FIG. 10 illustrates a signaling exchange for additionally characterizing a successful initialization of reporting procedure, from the first network node to the third network node, of estimates/predictions of resource utilization associated with the second network node.

In the example illustrated in FIG. 10, the first network node may additionally:
Receive an acknowledgment message from the second network node indicating that all or part of the requested resource utilization measurements can be provided by the second network node. The acknowledgment message may additionally specify changes to reporting configuration instructions/preferences received from the first network node.

Upon receiving an acknowledgment message from the second network, the first network node may additionally:
Determine which resource utilization predictions/estimates associated with the second network node can be realized, and
Transmit an acknowledgment message to the third network node indicating that all or part of the requested estimate/predictions of resource utilization associated with the second network node can be provided by the first network node. The acknowledgment message may additionally specify changes to reporting configuration instructions/preferences received from the third network node.

In both of the above cases, the RESOURCE UTILIZATION ACKNOWLEDGEMENT message could be implemented, for example, with existing signaling procedure such as a RESOURCE STATUS RESPONSE message of the 3GPP LTE and NR systems as illustrated in FIG. 10. The acknowledgment message from the first network node to the second network node may benefit from enhancements to specify that it is associated with predictions/estimates of resource utilization for the second network node.

### Signaling Failure Operation

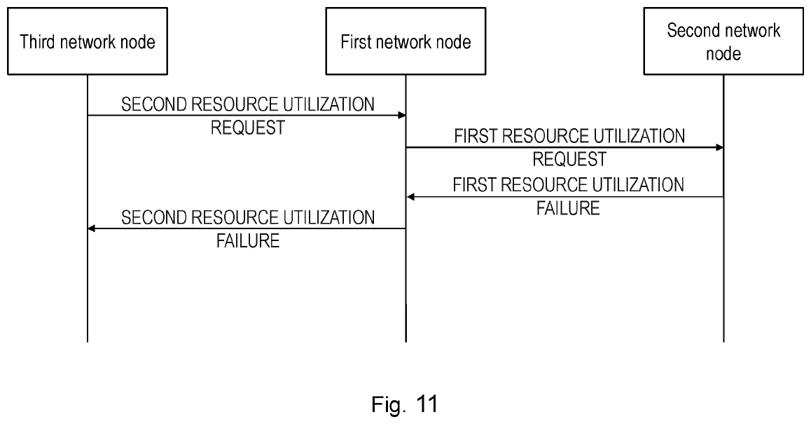

FIG. 11 illustrates a signaling exchange for additionally characterizing a failure initialization of reporting procedure, from the first network node to the third network node, of estimates/predictions of resource utilization associated with the second network node.

In the example illustrated in FIG. 11, the first network node may additionally:
Receive a first failure message from the second network node indicating that none of the requested resource utilization measurements can be provided by the second network node. The failure message may additionally specify cause of the failure event.
Transmit a second failure message to the third network node indicating that none of the requested resource utilization estimates/predictions associated with the second network node can be provided. The failure message may additionally specify cause of the failure event

Also in this case, the RESOURCE UTILIZATION FAILURE messages could be implemented, for example, with existing signaling procedure such as a RESOURCE STATUS FAILURE message of the 3GPP LTE and NR systems.

### Type of Resource Utilization Predictions

The SECOND RESOURCE UTILIZATION MESSAGE transmitted from the first network node to the third network node may comprise one or more information elements pertaining to predictions of resource status utilization for the second network node. The information elements may be selected from the group of:
Time window for which the prediction is considered valid
Predicted number of active UEs (where number of active UEs is defined in e.g. TS38.423)
Predicted QoE metrics or QoE score
Predicted QoS characteristics: GBR, PDB, PER etc.
Predicted RRC Connections and available RRC Connection Capacity
Predicted number of inactive UEs
Predicted Radio Resource Status, e.g. per-cell or per-SSB areas usage of DL and/or UL PRB (in total, for GBR and for non-GBR), per-cell or per-SSB areas usage of DL and/or UL scheduling PDCCH CCE
Predicted radio resource usage for Unlicensed spectrum
Predicted TNL Capacity, namely a prediction of the resources available over the transport network
Predicted capacity available over a specific radio coverage area of the node, in uplink and/or downlink, such a Composite Available Capacity, or an absolute available capacity.

Predicted Slice Available Capacity, in uplink and/or downlink namely a prediction of the capacity available over a specific radio coverage area of the node and for a specific network slice
Predicted traffic for each UE, for example probability of an arrival of packet within T seconds for each connected UE
Predicted size of data arrival in uplink or downlink for a UE within T seconds.
Predicted resource utilization in areas neighboring with specific coverage areas, for example:
   Resource utilization prediction at cell edge between cell with CGI x and Cell with CGI y
Predicted transmission power used per resource block in UL and DL
   This metric could be provided on a per UE basis of on a cumulative basis, i.e. counting all UEs using the same resource block within a given coverage area, or with respect to the criteria listed below
Uncertainty (accuracy, precision) indication for each one of the predicted resource statuses or an overall uncertainty indication for the overall prediction being exchanged

It will be appreciated that the metrics listed above may be collected according to at least one of the following criteria:
separately for uplink and downlink, combined for uplink and downlink,
per cell,
per DRB,
per 5QI,
per QCI
per intra cell coverage area, e.g. per SSB coverage area (e.g., per SSB index), per CSI-RS coverage area (e.g., per CSI-RS index)
per network slice
minimum, maximum, mean, median, average
per sharing PLMN

In one example of the methods disclosed herein, the SECOND RESOURCE UTILIZATION MESSAGE may comprise one or more predictions of resource status utilization according to the SECOND RESOURCE UTILIZATION REQUEST received from third network node.

### Processes for Prediction

The first network node may determine an estimate or a prediction of the future resource status information associated with the second network node by means, for instance, of machine learning algorithms or estimation algorithms. The first network node may combine one or more information elements including:
Collected historical data of measured resource status related to resources controlled by the first network node, for instance for cells that are neighboring to the second network node.
Collected historical data of measured resource status related to resources controlled by the second network node, e.g. by means of received resource status report updates received from the second network node comprising, for example, measurements of resource utilization/status relative to a previous time intervals, for example for cells that are neighboring to the first and third network node.
If available, collected historical data of measured resource status related to resources controlled by the third network node, e.g. by means of received resource status report updates received from the third network node comprising, for example, measurements of resource utilization/status relative to a previous time intervals, for example for cells that are neighboring to the second network node.
If available, predicted resource status for resources controlled by the first network node.
If available, predicted resource status for resources controlled by the second network node.
If available, predicted resource status for resources controlled by the third network node.

In another example, the prediction can comprise a time-offset and value related to a previous prediction. In a related example, the first or third nodes can select a threshold for the granularity of reporting. For example, first node reports a new value when a new predicted value is T larger than previous value. The first node then signals the time-instance when the predicted value is larger than the threshold T.

Example ML models suitable for generating the predicted future resource status information are listed above, and include an Autoregressive model, a Feedforward Neural Network, a Convolutional Neural Network, a graph-based Neural Network, a Recurrent Neural Network and/or a Long Short-Term Memory process. It will be appreciated that a wide range of algorithms may be used to generate predictions for one or more different resource use metrics, depending on the nature of the metric for which information is to be predicted, computation resources and capabilities available at the first network node, and available inputs, which include the obtained report of resource usage at the second node, but may also include any one or more of the elements listed above. For example, a regression algorithm may be used to predict a continuous variable in one example, or a continuous variable may be divided into different possible value ranges, and a classification algorithm may be used to predict a value range in which the variable is likely to sit. In other examples, classification algorithms may be used to predict whether a continuous variable will exceed a threshold level, or to predict a value of a discrete variable.

Non-limiting examples of estimation algorithms suitable for generating the predicted future resource status information include regression algorithms, Kalman filters, maximum likelihood algorithms, etc.

### Implementation Relating to the Third Network Node (Methods 500, 800)

According to another example implantation, the third node may:
Transmit to the first network node a SECOND RESOURCE UTILIZATION request to receive predictions of resource utilization associated with the second network node.

The SECOND RESOURCE UTILIZATION REQUEST could be implemented, for example, with enhancements to existing signaling procedures such as a RESOURCE STATUS REQUEST of the 3GPP LTE and NR systems as illustrated in FIG. 9. The request may specify which type of resource utilization metrics should be estimated/predicted, with what granularity (for example, in the frequency domain, time domain or spatial domain), the reporting mechanism, (for example, periodic or aperiodic reporting, reporting resources) etc. as detailed below.

The SECOND RESOURCE UTILIZATION REQUEST transmitted from the third network node to the first network node may comprise a request for one or more information elements pertaining to predictions of resource status utilization associated to resources controlled by the second network node. The information elements may be selected from the group of:
Time window for which the prediction is considered valid
Predicted number of active UEs (where number of active UEs is defined in e.g. TS38.423)
Predicted QoE metrics or QoE score
Predicted QoS characteristics: GBR, PDB, PER etc.
Predicted RRC Connections and available RRC Connection Capacity
Predicted number of inactive UEs
Predicted Radio Resource Status, e.g. per-cell or per-SSB areas usage of DL and/or UL PRB (in total, for GBR and for non-GBR), per-cell or per-SSB areas usage of DL and/or UL scheduling PDCCH CCE.
Predicted radio resource usage for Unlicensed spectrum
Predicted TNL Capacity, namely a prediction of the resources available over the transport network
Predicted capacity available over a specific radio coverage area of the node, in uplink and/or downlink, such a Composite Available Capacity, or an absolute available capacity.
Predicted Slice Available Capacity, in uplink and/or downlink namely a prediction of the capacity available over a specific radio coverage area of the node and for a specific network slice
Predicted traffic for each UE, for example probability of an arrival of packet within T seconds for each connected UE
Predicted size of data arrival in uplink or downlink for a UE within T seconds.
Predicted resource utilization in areas neighboring with specific coverage areas, for example:
   Resource utilization prediction at cell edge between cell with CGI x and Cell with CGI y
Predicted transmission power used per resource block in UL and DL
   This metric could be provided on a per UE basis of on a cumulative basis, i.e. counting all UEs using the same resource block within a given coverage area, or with respect to the criteria listed below
Uncertainty (accuracy, precision) indication for each one of the predicted resource statuses or an overall uncertainty indication for the overall prediction being exchanged

It will be appreciated that the metrics listed above may be collected according to at least one of the following criteria:
separately for uplink and downlink, combined for uplink and downlink,
per cell,
per DRB,
per 5QI,
per QCI
per intra cell coverage area, e.g. per SSB coverage area (e.g., per SSB index), per CSI-RS coverage area (e.g., per CSI-RS index)
per network slice
minimum, maximum, mean, median, average
per sharing PLMN

In one example of the methods disclosed herein, the SECOND RESOURCE UTILIZATION REQUEST may configure what the first network node should report in the SECOND RESOURCE UTILIZATION MESSAGE.

The third network node may additionally:
Receive a SECOND RESOURCE UTILIZATION message from the first network node, the second message comprising at least one estimate or prediction of the future resource utilization for at least one load metric associated with the second network node.
Receive an acknowledgment message from the first network node indicating that all or part of the requested estimate/predictions of resource utilization associated with the second network node can be provided by the first network node. The acknowledgment message may additionally specify changes to reporting configuration compared to instructions/preferences sent by the third network node.
Receive a second failure message from the first network node indicating that none of the requested resource utilization estimates/predictions associated with the second network node can be provided. The failure message may additionally specify cause of the failure event.

### Example Implementations for Specific Node Types

The following examples are illustrated and explained in the context of 3GPP LTE-A and 3GPP NG-RAN terminology, but it will be appreciated that these examples are not intended to be limiting upon the scope of the present disclosure. Similarly, the following examples are illustrated and explained using the RESOURCE UTILIZATION MESSAGE exchanged between the first network node and the second and third network nodes. However, will be appreciated that similar implementations of methods according to the present disclosure may be achieved using:
Transmission/reception of the RESOURCE UTILIZATION REQUEST MESSAGE
Transmission/reception of the RESOURCE UTILIZATION ACKNOWLEDGEMENT MESSAGE
Transmission/reception of the RESOURCE UTILIZATION FAILURE MESSAGE

As discussed above, the first network node, the second network node and the third network node can be any type of node in the group of: evolved NodeB (eNB), NG-RAN node (also knowns as gNB), en-gNB, ng-eNB, CU-CP, CU-UP, DU, gNB-CU, gNB-DU, gNB-CU-UP, gNB-CU-CP, eNB-CU, eNB-DU, eNB-CU-UP, eNB-CU-CP, IAB-node, IAB-donor DU, IAB-donor-CU, IAB-DU, IAB-MT, O-CU, O-CU-CP, O-CU-UP, O-DU, O-RU, O-eNB.

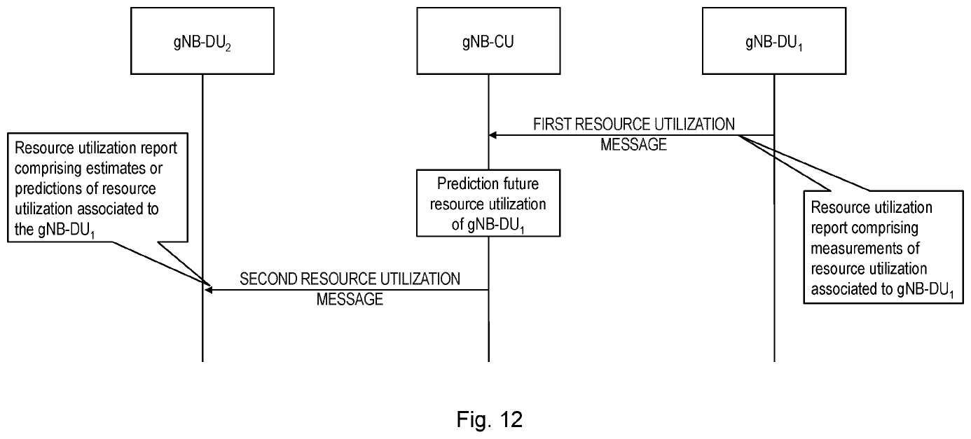

FIG. 12 illustrates implementation of methods according to the present disclosure in a RAN-split architecture. In one example, the first network node is a centralized unit of an NG-RAN node, i.e. a gNB-CU, while the second and third network nodes are two distributed units of a NG-RAN node (i.e., gNB-DU), that is gNB-DU1 and gNB-DU2, respectively, as illustrated in FIG. 12. In this example, the gNB-DU1 and gNB-DU2 are connected to the same gNB-CU via an F1 interface, but no direct communication interface exists between gNB-DU1 and gNB-DU2. Therefore, in this example, gNB-CU1 (the first network node) estimates/predicts future resource utilization associated with one or more radio cells (or parts of radio cells) controlled by the gNB-DU1 (the second network node). According to previous examples, the gNB-CU may then use the estimated resource utilization to optimize one or more network operation functions (such as, RACH optimization, mobility robustness optimization, load balancing optimization etc.) and/or signal this information to gNB-DU2 (the third network node).

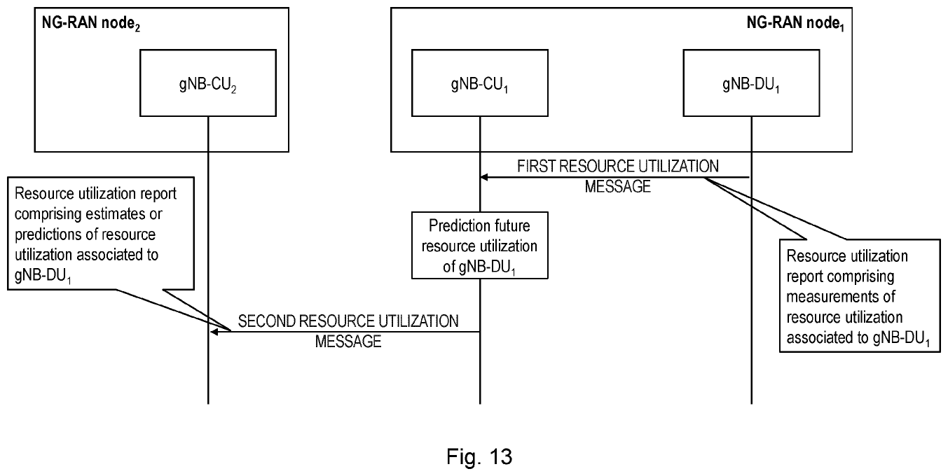

FIG. 13 illustrates implementation of methods according to the present disclosure for two NG-RAN nodes with split architecture, in which a gNB-CU signals the estimated resource utilization for one of its controlled gNB-DU to another gNB-CU.

In the example illustrated in FIG. 13, the first network node is a first centralized unit of a first NG-RAN node (i.e., gNB-CU1), the second network node is a distributed unit of the first NG-RAN node (i.e., gNB-DU), and the third network node is a second centralized unit of a second NG-RAN node (i.e., gNB-CU2. In this example, the gNB-CU1 (first network node) receives an indication of the current resource utilization from the gNB-DU1 (e.g., a RESOURCE STATUS UPDATE message of the 3GPP NG-RAN system) and uses this information to predict/estimate future resource utilization associated with one or more radio cells (or parts of radio cells) controlled by gNB-DU1, The gNB-CU1 (first network node) can then forward the predicted resource utilization for gNB-DU1 to second gNB-CU2 (third network node). This could be beneficial to optimize one or more network operation functions (such as, RACH optimization, mobility robustness optimization, load balancing optimization etc.) involving gNB-DUs of the two NG-RAN nodes (i.e., connected to either gNB-CU1 or gNB-CU2). In this example, gNB-CU1 (first network node) would transmit the estimated resource utilization for gNB-DU1 to gNB-CU2 via the Xn interface of the 3GPP NG-RAN system.

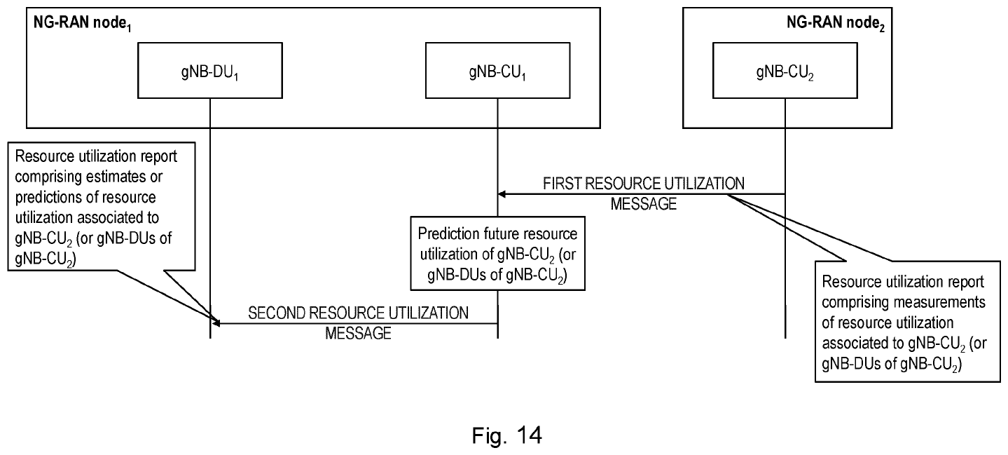

FIG. 14 illustrates implementation of methods according to the present disclosure for two NG-RAN nodes with split architecture, in which a gNB-CU estimates/predicts the resource utilization associated with a second gNB-CU (i.e., to one or more radio cell or part of radio cell of the second gNB-CU).

In the example illustrated in FIG. 14, the first network node is a centralized unit of a first NG-RAN node (i.e., gNB-CU1), the second network node is a centralized unit of a second NG-RAN node (i.e., gNB-CU2), while the third network node is a decentralized unit of the first NG-RAN node (i.e., gNB-DU1. In this example, the gNB-CU1 (first network node) receives an indication of the current resource utilization from the gNB-CU2 (e.g., a RESOURCE STATUS UPDATE message of the 3GPP NG-RAN system), which could be associated with one or more radio cells (or parts of radio cells) controlled by either the gNB-CU2 or by one or more gNB-DU connected to the gNB-CU2. The gNB-CU1 (first network node) uses the received resource utilization information to predict/estimate future resource utilization associated with the one or more radio cells (or parts of radio cells) of the gNB-CU2. The gNB-CU1 (first network node) can then forward the predicted resource utilization to one or more gNB-DUs (third network node). This is beneficial to optimize one or more network operation functions (such as, RACH optimization, mobility robustness optimization, load balancing optimization etc.) involving gNB-DUs of the two NG-RAN nodes (i.e., connected to either gNB-CU1 or gNB-CU2). In this example, gNB-CU1 would transmit the estimated resource utilization for gNB-CU2 to gNB-DU1 via the F1 interface of the 3GPP NG-RAN system.

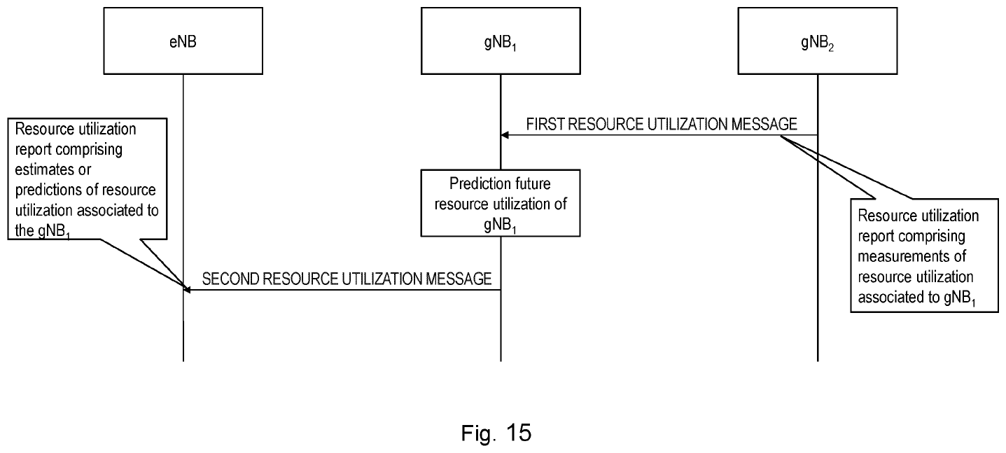

FIG. 15 illustrates implementation of methods according to the present disclosure for an NG-RAN system and an E-UTRAN system, with resource utilization prediction of the NG-RAN system transmitted to the E-UTRAN system.

In the example illustrated in FIG. 15, the first network node is first a NG-RAN node of an NG-RAN system (i.e., a gNB1), the second network node is a second NG-RAN node of the NG-RAN system (i.e., a gNB2), and the third network node is a E-UTRAN node (i.e., a gNB). In this example, the gNB1 (first network node) receives an indication of the current resource utilization from the gNB2 (e.g., a RESOURCE STATUS UPDATE message of the 3GPP NG-RAN system), which could be associated with one or more radio cells (or parts of radio cells) controlled by the gNB2. The gNB1 (first network node) uses the received resource utilization information to predict/estimate future resource utilization associated with the one or more radio cells (or parts of radio cells) of the gNB2. The gNB1 (first network node) can then forward the predicted resource utilization to one or more eNBs of an E-UTRAN system (third network node). This is beneficial to optimize one or more network operation functions (such as, RACH optimization, mobility robustness optimization, load balancing optimization etc.) involving an NG-RAN node and an E-UTRAN node. In this example, gNB1 would transmit the estimated resource utilization for gNB2 to the eNB via an X2 interface of a 3GPP system.

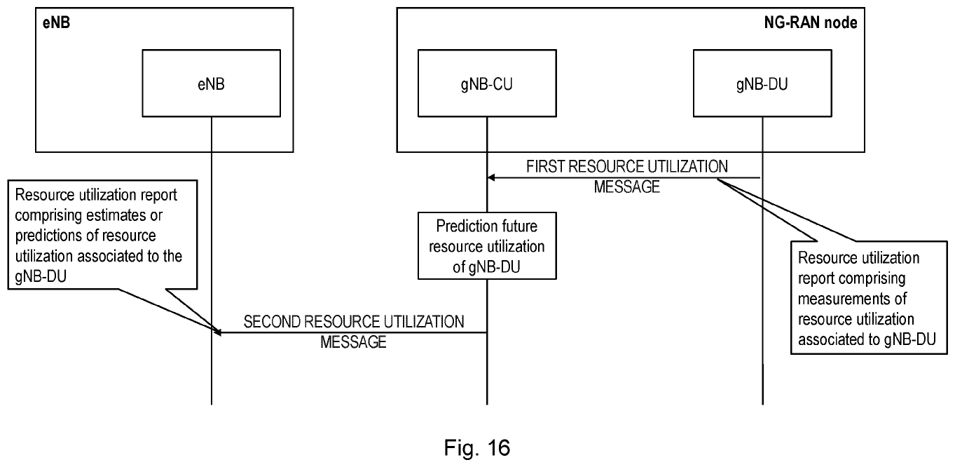

FIG. 16 illustrates implementation of methods according to the present disclosure for an NG-RAN node (with split architecture) of a E-UTRAN node (i.e., a eNB) in which the NG-RAN node transmits to the eNB an indication of estimated/predicted resource utilization for at least a gNB-DU.

In the example illustrated in FIG. 16 the first network node is a centralized unit of a NG-RAN node (i.e., gNB-CU), the second network node is a decentralized unit the NG-RAN node (i.e., a gNB-DU), while the third network node an E-UTRAN node such as an eNB. In this example, the gNB-CU (first network node) receives an indication of the current resource utilization from the gNB-DU (e.g., a RESOURCE STATUS UPDATE message of the 3GPP NG-RAN system), which could be associated with one or more radio cells (or parts of radio cells) controlled by the gNB-DU. The gNB-CU (first network node) uses the received resource utilization information to predict/estimate future resource utilization associated with the one or more radio cells (or parts of radio cells) of the gNB-DU. The gNB-CU (first network node) can then forward the predicted resource utilization to one or more eNBs of an E-UTRAN system (third network node). This is beneficial to optimize one or more network operation functions (such as, RACH optimization, mobility robustness optimization, load balancing optimization etc.) involving an NG-RAN node and an E-UTRAN node. In this example, gNB-CU would transmit the estimated resource utilization to the eNB via an X2 interface of a 3GPP system.

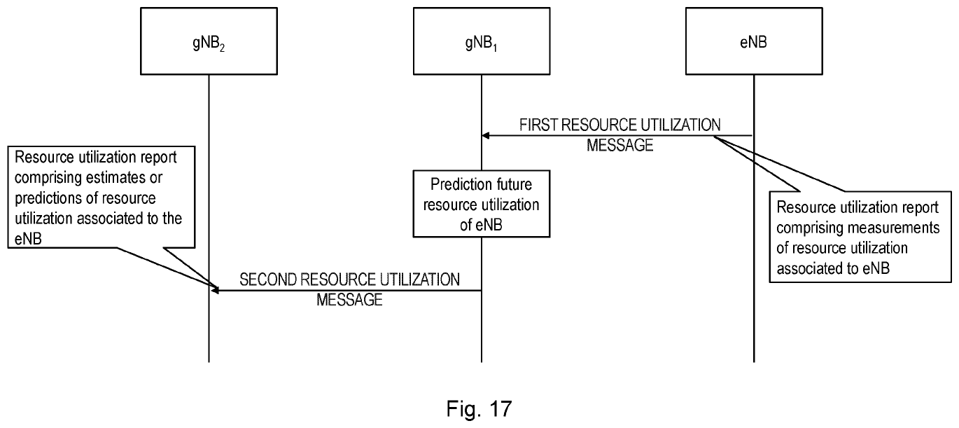

FIG. 17 illustrates implementation of methods according to the present disclosure for an NG-RAN system and an E-UTRAN system, with resource utilization prediction of the E-UTRAN system transmitted within the NG-RAN system.

In the example illustrated in FIG. 17, the first network node is a first NG-RAN node of an NG-RAN system (e.g., a gNB1), the second network node is a E-UTRAN node (e.g., an eNB) of an E-UTRAN system, and the third network node is second NG-RAN node of the NG-RAN system (e.g., a gNB2). In this example, the gNB1 (first network node) receives an indication of the current resource utilization from the eNB (e.g., a RESOURCE STATUS UPDATE message of the 3GPP system), which could be associated with one or more radio cells (or parts of radio cells) controlled by the eNB. The gNB1 (first network node) uses the received resource utilization information to predict/estimate future resource utilization associated with the one or more radio cells (or parts of radio cells) of the eNB. The gNB1 can then forward the predicted resource utilization to one or more eNBs of the NG-RAN system (third network node). This is beneficial to optimize one or more network operation functions (such as, RACH optimization, mobility robustness optimization, load balancing optimization etc.) involving an NG-RAN node and an E-UTRAN node. In this example, gNB1 would transmit the estimated resource utilization for the eNB to the gNB2 via an Xn interface of a 3GPP system.

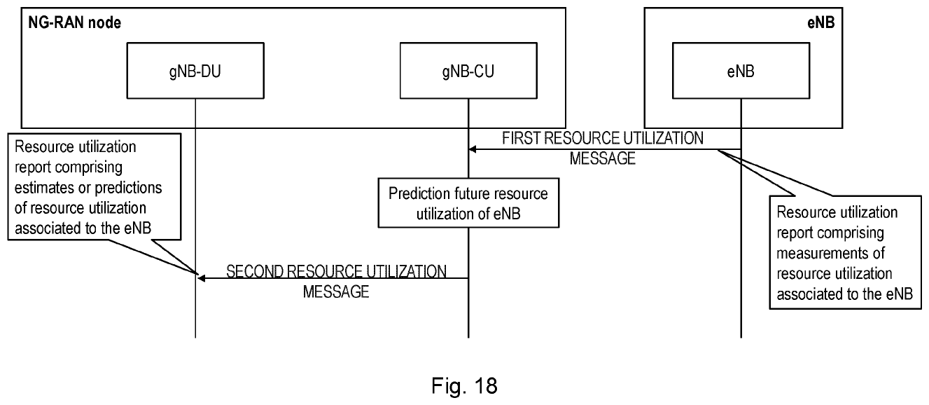

FIG. 18 illustrates implementation of methods according to the present disclosure for an NG-RAN node with split architecture and an E-UTRAN node, with resource utilization prediction of the E-UTRAN node transmitted within the NG-RAN node components.

In the example of FIG. 18, the first network node is a centralized unit of an NG-RAN node (i.e., gNB-CU), the second network node is a E-UTRAN node (e.g., an eNB) of an E-UTRAN system, while the third network node is a decentralized unit of the NG-RAN node (i.e., a gNB-DU). In this example, the gNB-CU (first network node) receives an indication of the current resource utilization from the eNB (e.g., a RESOURCE STATUS UPDATE message of the 3GPP NG-RAN system), which could be associated with one or more radio cells (or parts of radio cells) controlled by either the eNB. The gNB-CU (first network node) uses the received resource utilization information to predict/estimate future resource utilization associated with the one or more radio cells (or parts of radio cells) of the eNB (second network node). The gNB-CU can then forward the predicted resource utilization to one or more gNB-DU of the NG-RAN system (third network node). In this example, gNB-CU would transmit the estimated resource utilization for eNB to the gNB-DU via an F1 interface of a 3GPP system

In an alternative example, not illustrated in FIG. 18, the third network node may be a second centralized unit of a second NG-RAN node, and the first gNB-CU forwards the predicted resource utilization for the eNB to one or more second gNB-CU of the NG-RAN system. In this example, gNB-CU would transmit the estimated resource utilization for eNB to the second gNB-CU via an Xn interface of a 3GPP system

This is beneficial to optimize one or more network operation functions (such as, RACH optimization, mobility robustness optimization, load balancing optimization etc.) involving an NG-RAN node and an E-UTRAN node.

### Implementation in XnAP

There now follows an illustration of how example methods according to the present disclosure may be implemented using the XnAP procedure (3GPP TS 38.423 v16.5.0). The elements marked in Italic are specific to the present disclosure.

It will be appreciated that the following language is intended to represent typical syntax used in 3GPP specifications. The example consequently refers to the signaling between two NG-RAN nodes, referred to as NG-RAN node₁ and NG-RAN node₂, respectively. NG-RAN node₁ is an example of a third network node according to the present disclosure, and NG-RAN node₂ is an example of the first network node in the disclosure.

### 9.1.3.18 Resource Status Request

This message is sent by NG-RAN node₁ to NG-RAN node₂ to initiate a requested measurement according to the parameters given in the message.

Direction: NG-RAN node₁ to NG-RAN node₂.

| | | | IE type and |
|---|---|---|---|
| IE/Group Name | Presence | Range | reference |
| Message Type | M | | 9.2.3.1 |
| NG-RAN node1 | M | | INTEGER |
| Measurement ID | | | (1 . . . |
| | | | 4095, . . .) |
| NG-RAN node2 | C- | | INTEGER |
| Measurement ID | ifRegistrationRequestStoporAdd | | (1 . . . |
| | | | 4095, . . .) |
| Registration Request | M | | ENUMERATED(start, |
| | | | stop, add, . . .) |
| Report Characteristics | C- | | BITSTRING |
| | ifRegistrationRequestStart | | (SIZE(32)) |
| Cell To Report List | | 0 . . . 1 | |
| >Cell To Report Item | | 1 . . . | |
| | | <maxnoofCellsinNG-RANnode> | |
| >>Cell ID | M | | Global NG-RAN Cell |
| | | | Identity 9.2.2.27 |
| >>SSB To Report | | 0 . . . 1 | |
| List | | | |
| >>>SSB To Report | | 1 . . . | |
| Item | | <maxnoofSSBAreas> | |
| >>>>SSB-Index | M | | INTEGER |
| | | | (0 . . . , 63 . . .) |
| >>Slice To Report | | 0 . . . 1 | |
| List | | | |
| >>>Slice To Report | | 1 . . . | |
| Item | | <maxnoofBPLMNs> | |
| >>>>PLMN Identity | M | | 9.3.1.14 |
| >>>>S-NSSAI List | | 1 | |
| >>>>>S-NSSAI Item | | 1 . . . | |
| | | <maxnoofSliceItems> | |
| >>>>>>S-NSSAI | M | | S-NSSAI 9.3.1.38 |
| Reporting Periodicity | O | | ENUMERATED(500 ms, |
| | | | 1000 ms, 2000 ms, |
| | | | 5000 ms, 10000 ms, |
| | | | . . .) |
| Indirect prediction | | 0 . . . <maxnoofNG- | |
| Request | | RANnodesForPrediction> | |
| > Global NG_{—}RAN | M | | 9.2.2.3 |
| Node ID | | | |
| > Cell Measurement | | 1 . . . | |
| Result Item | | <maxnoofCellsinNG-RANnode> | |
| >> Cell ID | M | | Global NG-RAN Cell |
| | | | Identity 9.2.2.27 |
| >>>SSB To Report | | 0 . . . 1 | |
| List | | | |
| >>>>SSB To Report | | 1 . . . | |
| Item | | <maxnoofSSBAreas> | |
| >>>>>SSB-Index | M | | INTEGER |
| | | | (0 . . . , 63 . . .) |
| >>>Slice To Report | | 0 . . . 1 | |
| List | | | |
| >>>>Slice To Report | | 1 . . . | |
| Item | | <maxnoofBPLMNs> | |
| >>>>>PLMN Identity | M | | 9.3.1.14 |
| >>>>>S-NSSAI List | | 1 | |
| >>>>>>S-NSSAI Item | | 1 . . . | |
| | | <maxnoofSliceItems> | |
| >>>>>>>S-NSSAI | M | | S-NSSAI 9.3.1.38 |

| | Semantics | | Assigned |
|---|---|---|---|
| IE/Group Name | description | Criticality | Criticality |
| Message Type | | YES | reject |
| NG-RAN node1 | Allocated by NG-RAN node₁ | YES | reject |
| Measurement ID | | | |
| NG-RAN node2 | Allocated by NG-RAN node₂ | YES | ignore |
| Measurement ID | | | |
| Registration Request | Type of request for which the | YES | reject |
| | resource status is required. | | |
| Report Characteristics | Each position in the bitmap | YES | reject |
| | indicates measurement object | | |
| | the NG-RAN node2 is requested | | |
| | to report. | | |
| | First Bit = PRB Periodic, | | |
| | Second Bit = TNL Capacity | | |
| | Ind Periodic, | | |
| | Third Bit = Composite | | |
| | Available Capacity Periodic, | | |
| | Fourth Bit = Number of Active | | |
| | UEs, | | |
| | Fifth Bit = RRC connections. | | |
| | Other bits shall be ignored | | |
| | by the NG-RAN node2. | | |
| Cell To Report List | Cell ID list to which the | YES | ignore |
| | request applies. | | |
| >Cell To Report Item | | — | |
| >>Cell ID | | | |
| >>SSB To Report | SSB list to whichthe request | — | |
| List | applies. | | |
| >>>SSB To Report | | — | |
| Item | | | |
| >>>>SSB-Index | | — | |
| >>Slice To Report | S-NSSAI list to which the | — | |
| List | request applies. | | |
| >>>Slice To Report | | — | |
| Item | | | |
| >>>>PLMN Identity | Broadcast PLMN | — | |
| >>>>S-NSSAI List | | — | |
| >>>>>S-NSSAI Item | | — | |
| >>>>>>S-NSSAI | | — | |
| Reporting Periodicity | Periodicity that can be used | YES | Ignore |
| | for reporting of PRB Periodic, | | |
| | TNL Capacity Ind Periodic, | | |
| | Composite Available Capacity | | |
| | Periodic. Also used as the | | |
| | averaging window length for | | |
| | all measurement object if | | |
| | supported. | | |
| Indirect prediction | Request for indirect prediction | YES | Ignore |
| Request | updates | | |
| > Global NG_{—}RAN | NG-RAN node for which prediction | YES | Reject |
| Node ID | updates are requested | | |
| > Cell Measurement | | | |
| Result Item | | | |
| >> Cell ID | | — | |
| >>>SSB To Report | SSB list to which the request | — | |
| List | applies. | | |
| >>>>SSB To Report | | — | |
| Item | | | |
| >>>>>SSB-Index | | — | |
| >>>Slice To Report | S-NSSAI list to which the request | — | |
| List | applies. | | |
| >>>>Slice To Report | | — | |
| Item | | | |
| >>>>>PLMN Identity | Broadcast PLMN | — | |
| >>>>>S-NSSAI List | | — | |
| >>>>>>S-NSSAI Item | | — | |
| >>>>>>>S-NSSAI | | — | |

| | Explanation |
|---|---|
| Condition | |
| ifRegistrationRequestStoporAdd | This IE shall be present if the Registration Request IE is set to |
| | the value “stop” or “add”. |
| ifRegistrationRequestStart | This IE shall be present if the Registration Request IE is set to |
| | the value “start”. |
| Range bound | |
| maxnoofCellsinNG-RANnode | Maximum no. cells that can be served by a NG-RAN node. |
| | Value is 16384. |
| maxnoofSSBAreas | Maximum no. SSB Areas that can be served by a NG-RAN |
| | node cell. Value is 64. |
| maxnoofSliceltems | Maximum no. of signalled slice support items. Value is 1024. |
| maxnoofNG-RANnodesForPrediction | Maximum no. NG-RAN nodes for which predictions can be |
| | provided. Value is 32. |

### 9.1.3.21 Resource Status Update

This message is sent by NG-RAN node₂ to NG-RAN node₁ to report the results of the requested measurements.

Direction: NG-RAN node₂ to NG-RAN node₁.

| | | | IE type and | Semantics | | Assigned |
|---|---|---|---|---|---|---|
| IE/Group Name | Presence | Range | reference | description | Criticality | Criticality |
| Message Type | M | | 9.2.3.1 | | YES | ignore |
| NG-RAN node1 | M | | INTEGER | Allocated by | YES | reject |
| Measurement ID | | | (1 . . . | NG-RAN node₁ | | |
| | | | 4095, . . .) | | | |
| NG-RAN node2 | M | | INTEGER | Allocated by | YES | reject |
| Measurement ID | | | (1 . . . | NG-RAN node₂ | | |
| | | | 4095, . . .) | | | |
| Cell Measurement | | 1 | | | YES | ignore |
| Result | | | | | | |
| >Cell Measurement | | 1 . . . | | | YES | ignore |
| Result Item | | <maxnoofCellsinNG- | | | | |
| | | RANnode> | | | | |
| >>Cell ID | M | | Global NG-RAN | | — | |
| | | | Cell Identity | | | |
| | | | 9.2.2.27 | | | |
| >>Radio Resource | O | | 9.2.2.50 | | — | |
| Status | | | | | | |
| >>TNL Capacity | O | | 9.2.2.49 | | — | |
| Indicator | | | | | | |
| >>Composite | O | | 9.2.2.51 | | — | |
| Available Capacity | | | | | | |
| Group | | | | | | |
| >>Slice Available | O | | 9.2.2.55 | | — | |
| Capacity | | | | | | |
| >>Number of Active | O | | 9.2.2.62 | | — | |
| UEs | | | | | | |
| >> RRC Connections | O | | 9.2.2.56 | | — | |
| Indirect prediction | | 0 . . . <maxnoofNG- | | Information | YES | Ignore |
| updates | | RANnodesForPrediction> | | requested for | | |
| | | | | indirect | | |
| | | | | forwarding of | | |
| | | | | prediction | | |
| | | | | updates. | | |
| Time of prediction | M | | ENUMERATED | | | |
| validity | | | (100 ms, 200, | | | |
| | | | 500 ms, 1 s, 2 s, | | | |
| | | | 5 s, 10 s, 20 s | | | |
| | | | 30 s, 40 s, 50 s, | | | |
| | | | 1 m, 2 m, 5 m, | | | |
| | | | 10 m, 20 m, 30 m, | | | |
| | | | 40 m, 50 m, | | | |
| | | | 1 h, . . .) | | | |
| Predicted uncertainty | M | | INTEGER | | | |
| | | | (0 . . . 100) | | | |
| > Global NG_{—}RAN | M | | 9.2.2.3 | NG-RAN node | YES | Reject |
| Node ID | | | | for which | | |
| | | | | prediction | | |
| | | | | updates are | | |
| | | | | provided | | |
| > Cell Measurement | | 1 . . . | | | | |
| Result Item | | <maxnoofCellsinNG- | | | | |
| | | RANnode> | | | | |
| >> Cell ID | M | | Global NG-RAN | | — | |
| | | | Cell Identity | | | |
| | | | 9.2.2.27 | | | |
| >> Radio Resource | M | | 9.2.2.50 | | | |
| Status Prediction | | | | | | |
| Update | | | | | | |
| >> TNL Capacity | M | | 9.2.2.49 | | | |
| Indicator Prediction | | | | | | |
| Update | | | | | | |
| >> Composite | M | | 9.2.2.51 | | | |
| Available Capacity | | | | | | |
| Group Prediction | | | | | | |
| Update | | | | | | |
| >> Slice Available | O | | 9.2.2.55 | | | |
| Capacity Prediction | | | | | | |
| Update | | | | | | |
| >> Number of Active | O | | 9.2.2.62 | | | |
| UEs Prediction | | | | | | |
| Update | | | | | | |
| >> RRC Connection | O | | 9.2.2.56 | | | |
| Prediction Update | | | | | | |

| Range bound | Explanation |
|---|---|
| maxnoofCellsinNG-RANnode | Maximum no. cells that can be served by a NG-RAN node. Value is |
| | 16384. |
| maxnoofNG-RANnodesForPrediction | Maximum no. NG-RAN nodes for which predictions can be provided. |
| | Value is 32. |

### Node Apparatus

As discussed above, the methods 400 and 700 are implemented by a first node in a RAN, and the present disclosure provides a first node that is adapted to perform any or all of the steps of the above discussed methods. The first node may be a physical or virtual node, and may for example comprise a virtualised function that is running in a cloud, edge cloud or fog deployment. The first node may for example comprise or be instantiated in any part of a logical Radio Access node. Any such communication network node may itself be divided between several logical and/or physical functions, and any one or more parts of the management node may be instantiated in one or more logical or physical functions of a communication network node.

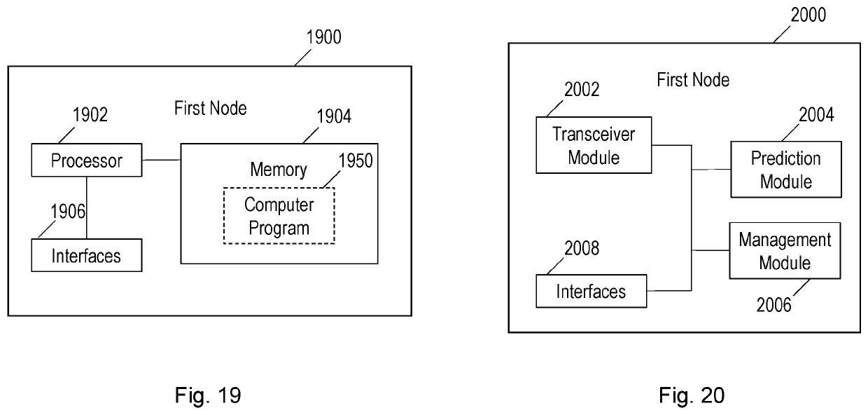

FIG. 19 is a block diagram illustrating an example first node 1900 which may implement the method 400 and/or 700, as illustrated in FIGS. 4 and 7a-f, according to examples of the present disclosure, for example on receipt of suitable instructions from a computer program 1950. Referring to FIG. 19, the first node 1900 comprises a processor or processing circuitry 1902, and may comprise a memory 1904 and interfaces 1906. The processing circuitry 1902 is operable to perform some or all of the steps of the method 400 and/or 700as discussed above with reference to FIGS. 4 and 7a-f. The memory 1904 may contain instructions executable by the processing circuitry 1902 such that the first node 1900 is operable to perform some or all of the steps of the method 400 and/or 700, as illustrated in FIGS. 4 and 7a-f. The instructions may also include instructions for executing one or more telecommunications and/or data communications protocols. The instructions may be stored in the form of the computer program 1950. In some examples, the processor or processing circuitry 1902 may include one or more microprocessors or microcontrollers, as well as other digital hardware, which may include digital signal processors (DSPs), special-purpose digital logic, etc. The processor or processing circuitry 1902 may be implemented by any type of integrated circuit, such as an Application Specific Integrated Circuit (ASIC), Field Programmable Gate Array (FPGA) etc. The memory 1904 may include one or several types of memory suitable for the processor, such as read-only memory (ROM), random-access memory, cache memory, flash memory devices, optical storage devices, solid state disk, hard disk drive etc.

FIG. 20 illustrates functional modules in another example of first node 2000 of a RAN which may execute examples of the methods 400 and/or 700 of the present disclosure, for example according to computer readable instructions received from a computer program. It will be understood that the modules illustrated in FIG. 20 are functional modules, and may be realised in any appropriate combination of hardware and/or software. The modules may comprise one or more processors and may be integrated to any degree.

Referring to FIG. 20, the first node 2000 is for managing resources in a RAN of a communication network. The first node comprises a transceiver module 2002 for obtaining a record of resource status information describing usage, during a historical time period, of RAN resources controlled by a second node in the RAN. The first node 2000 further comprises a prediction module 2004 for predicting, based on the obtained record, resource status information describing usage of RAN resources controlled by the second node during a future time period. The first node may further comprise a management module 2006 for using the predicted resource status information describing usage of RAN resources controlled by the second node in a process relating to management of RAN resources controlled by the first node. The transceiver module 2002 may also be for sending, to a third node in the RAN, a representation of the predicted resource status information describing usage of RAN resources controlled by the second node. The first node 2000 may further comprise interfaces 2008 which may be operable to facilitate communication with a serving cell of the UE, a management node, and/or with neighbour cells over suitable communication channels.

As discussed above, the methods 500 and 800 may be performed by a third node in a RAN, and the present disclosure provides a third node that is adapted to perform any or all of the steps of the above discussed methods. The third node may be a physical or virtual node, and may for example comprise a virtualised function that is running in a cloud, edge cloud or fog deployment. The third node may for example comprise or be instantiated in any part of a logical Radio Access node. Any such communication network node may itself be divided between several logical and/or physical functions, and any one or more parts of the management node may be instantiated in one or more logical or physical functions of a communication network node.

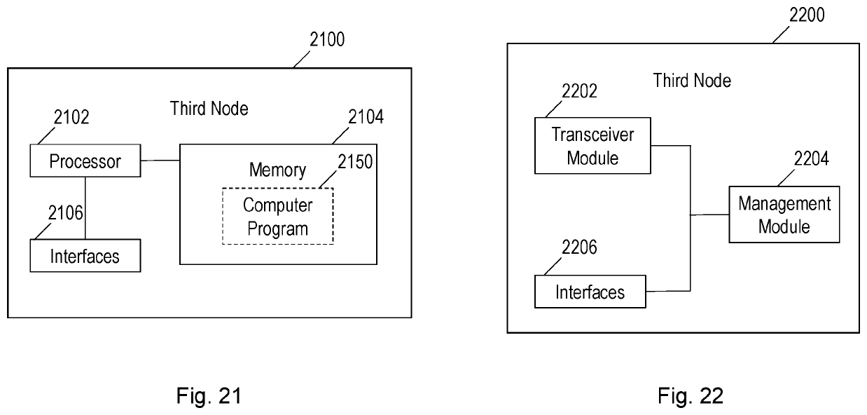

FIG. 21 is a block diagram illustrating an example third node 2100 which may implement the method 500 and/or 800, as illustrated in FIGS. 5 and 8a-b, according to examples of the present disclosure, for example on receipt of suitable instructions from a computer program 2150. Referring to FIG. 21, the third node 2100 comprises a processor or processing circuitry 2102, and may comprise a memory 2104 and interfaces 2106. The processing circuitry 2102 is operable to perform some or all of the steps of the method 500 and/or 800 as discussed above with reference to FIGS. 5 and 8a-b. The memory 2104 may contain instructions executable by the processing circuitry 2102 such that the third node 2100 is operable to perform some or all of the steps of the method 500 and/or 800, as illustrated in FIGS. 5 and 8a-b. The instructions may also include instructions for executing one or more telecommunications and/or data communications protocols. The instructions may be stored in the form of the computer program 2150. In some examples, the processor or processing circuitry 2102 may include one or more microprocessors or microcontrollers, as well as other digital hardware, which may include digital signal processors (DSPs), special-purpose digital logic, etc. The processor or processing circuitry 2102 may be implemented by any type of integrated circuit, such as an Application Specific Integrated Circuit (ASIC), Field Programmable Gate Array (FPGA) etc. The memory 2104 may include one or several types of memory suitable for the processor, such as read-only memory (ROM), random-access memory, cache memory, flash memory devices, optical storage devices, solid state disk, hard disk drive etc.

FIG. 22 illustrates functional modules in another example of third node 2200 which may execute examples of the methods 500 and/or 800 of the present disclosure, for example according to computer readable instructions received from a computer program. It will be understood that the modules illustrated in FIG. 22 are functional modules, and may be realised in any appropriate combination of hardware and/or software. The modules may comprise one or more processors and may be integrated to any degree.

Referring to FIG. 22, the third node 2200 is for managing resources in a RAN of a communication network. The third node comprises a transceiver module 2202 for receiving, from a first node in the RAN, a representation of predicted resource status information describing usage of RAN resources controlled by a second node in the RAN during a future time period. The third node further comprises a management module for using the predicted resource status information describing usage of RAN resources controlled by the second node in a process relating to management of RAN resources controlled by the third node. The third node 2200 may further comprise interfaces 2206 which may be operable to facilitate communication with a serving cell of the UE, the UE and/or with neighbour cells over suitable communication channels.

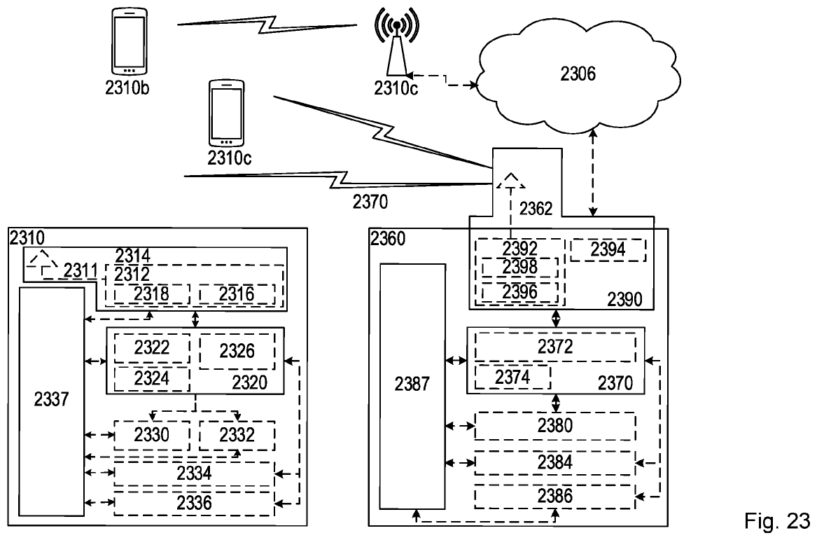

Although the subject matter described herein may be implemented in any appropriate type of system using any suitable components, the embodiments disclosed herein are described in relation to a wireless network, such as the example wireless network illustrated in FIG. 23. For simplicity, the wireless network of FIG. 23 only depicts network 2306, network nodes 2360 and 2360b, and WDs 2310, 2310b, and 2310c. In practice, a wireless network may further include any additional elements suitable to support communication between wireless devices or between a wireless device and another communication device, such as a landline telephone, a service provider, or any other network node or end device. Of the illustrated components, network node 2360 and wireless device (WD) 2310 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 2306 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 2360 and WD 2310 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 23, network node 2360 includes processing circuitry 2370, device readable medium 2380, interface 2390, auxiliary equipment 2384, power source 2386, power circuitry 2387, and antenna 2362. Although network node 2360 illustrated in the example wireless network of FIG. 23 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 2360 are depicted as single boxes located within a larger box, or nested within multiple boxes, in practice, a network node may comprise multiple different physical components that make up a single illustrated component (e.g., device readable medium 2380 may comprise multiple separate hard drives as well as multiple RAM modules).

Similarly, network node 2360 may be composed of multiple physically separate components (e.g., a NodeB component and a RNC component, or a BTS component and a BSC component, etc.), which may each have their own respective components. In certain scenarios in which network node 2360 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 2360 may be configured to support multiple radio access technologies (RATs). In such embodiments, some components may be duplicated (e.g., separate device readable medium 2380 for the different RATs) and some components may be reused (e.g., the same antenna 2362 may be shared by the RATs).

Network node 2360 may also include multiple sets of the various illustrated components for different wireless technologies integrated into network node 2360, such as, for example, GSM, WCDMA, LTE, NR, WiFi, or Bluetooth wireless technologies. These wireless technologies may be integrated into the same or different chip or set of chips and other components within network node 2360.

Processing circuitry 2370 is configured to perform any determining, calculating, or similar operations (e.g., certain obtaining operations) described herein as being provided by a network node. These operations performed by processing circuitry 2370 may include processing information obtained by processing circuitry 2370 by, for example, converting the obtained information into other information, comparing the obtained information or converted information to information stored in the network node, and/or performing one or more operations based on the obtained information or converted information, and as a result of said processing making a determination.

Processing circuitry 2370 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 2360 components, such as device readable medium 2380, network node 2360 functionality. For example, processing circuitry 2370 may execute instructions stored in device readable medium 2380 or in memory within processing circuitry 2370. Such functionality may include providing any of the various wireless features, functions, or benefits discussed herein. In some embodiments, processing circuitry 2370 may include a system on a chip (SOC).

In some embodiments, processing circuitry 2370 may include one or more of radio frequency (RF) transceiver circuitry 2372 and baseband processing circuitry 2374. In some embodiments, radio frequency (RF) transceiver circuitry 2372 and baseband processing circuitry 2374 may be on separate chips (or sets of chips), boards, or units, such as radio units and digital units. In alternative embodiments, part or all of RF transceiver circuitry 2372 and baseband processing circuitry 2374 may be on the same chip or set of chips, boards, or units.

In certain embodiments, some or all of the functionality described herein as being provided by a network node, base station, eNB or other such network device may be performed by processing circuitry 2370 executing instructions stored on device readable medium 2380 or memory within processing circuitry 2370. In alternative embodiments, some or all of the functionality may be provided by processing circuitry 2370 without executing instructions stored on a separate or discrete device readable medium, such as in a hard-wired manner. In any of those embodiments, whether executing instructions stored on a device readable storage medium or not, processing circuitry 2370 can be configured to perform the described functionality. The benefits provided by such functionality are not limited to processing circuitry 2370 alone or to other components of network node 2360, but are enjoyed by network node 2360 as a whole, and/or by end users and the wireless network generally.

Device readable medium 2380 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 2370. Device readable medium 2380 may store any suitable instructions, data or information, including a computer program, software, an application including one or more of logic, rules, code, tables, etc. and/or other instructions capable of being executed by processing circuitry 2370 and, utilized by network node 2360. Device readable medium 2380 may be used to store any calculations made by processing circuitry 2370 and/or any data received via interface 2390. In some embodiments, processing circuitry 2370 and device readable medium 2380 may be considered to be integrated.

Interface 2390 is used in the wired or wireless communication of signalling and/or data between network node 2360, network 2306, and/or WDs 2310. As illustrated, interface 2390 comprises port(s)/terminal(s) 2394 to send and receive data, for example to and from network 2306 over a wired connection. Interface 2390 also includes radio front end circuitry 2392 that may be coupled to, or in certain embodiments a part of, antenna 2362. Radio front end circuitry 2392 comprises filters 2398 and amplifiers 2396. Radio front end circuitry 2392 may be connected to antenna 2362 and processing circuitry 2370. Radio front end circuitry may be configured to condition signals communicated between antenna 2362 and processing circuitry 2370. Radio front end circuitry 2392 may receive digital data that is to be sent out to other network nodes or WDs via a wireless connection. Radio front end circuitry 2392 may convert the digital data into a radio signal having the appropriate channel and bandwidth parameters using a combination of filters 2398 and/or amplifiers 2396. The radio signal may then be transmitted via antenna 2362. Similarly, when receiving data, antenna 2362 may collect radio signals which are then converted into digital data by radio front end circuitry 2392. The digital data may be passed to processing circuitry 2370. In other embodiments, the interface may comprise different components and/or different combinations of components.

In certain alternative embodiments, network node 2360 may not include separate radio front end circuitry 2392, instead, processing circuitry 2370 may comprise radio front end circuitry and may be connected to antenna 2362 without separate radio front end circuitry 2392. Similarly, in some embodiments, all or some of RF transceiver circuitry 2372 may be considered a part of interface 2390. In still other embodiments, interface 2390 may include one or more ports or terminals 2394, radio front end circuitry 2392, and RF transceiver circuitry 2372, as part of a radio unit (not shown), and interface 2390 may communicate with baseband processing circuitry 2374, which is part of a digital unit (not shown).

Antenna 2362 may include one or more antennas, or antenna arrays, configured to send and/or receive wireless signals. Antenna 2362 may be coupled to radio front end circuitry 2390 and may be any type of antenna capable of transmitting and receiving data and/or signals wirelessly. In some embodiments, antenna 2362 may comprise one or more omni-directional, sector or panel antennas operable to transmit/receive radio signals between, for example, 2 GHZ and 66 GHZ. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 2362 may be separate from network node 2360 and may be connectable to network node 2360 through an interface or port.

Antenna 2362, interface 2390, and/or processing circuitry 2370 may be configured to perform any receiving operations and/or certain obtaining operations described herein as being performed by a network node. Any information, data and/or signals may be received from a wireless device, another network node and/or any other network equipment. Similarly, antenna 2362, interface 2390, and/or processing circuitry 2370 may be configured to perform any transmitting operations described herein as being performed by a network node. Any information, data and/or signals may be transmitted to a wireless device, another network node and/or any other network equipment.

Power circuitry 2387 may comprise, or be coupled to, power management circuitry and is configured to supply the components of network node 2360 with power for performing the functionality described herein. Power circuitry 2387 may receive power from power source 2386. Power source 2386 and/or power circuitry 2387 may be configured to provide power to the various components of network node 2360 in a form suitable for the respective components (e.g., at a voltage and current level needed for each respective component). Power source 2386 may either be included in, or external to, power circuitry 2387 and/or network node 2360. For example, network node 2360 may be connectable to an external power source (e.g., an electricity outlet) via an input circuitry or interface such as an electrical cable, whereby the external power source supplies power to power circuitry 2387. As a further example, power source 2386 may comprise a source of power in the form of a battery or battery pack which is connected to, or integrated in, power circuitry 2387. The battery may provide backup power should the external power source fail. Other types of power sources, such as photovoltaic devices, may also be used.

Alternative embodiments of network node 2360 may include additional components beyond those shown in FIG. 23 that may be responsible for providing certain aspects of the network node's functionality, including any of the functionality described herein and/or any functionality necessary to support the subject matter described herein. For example, network node 2360 may include user interface equipment to allow input of information into network node 2360 and to allow output of information from network node 2360. This may allow a user to perform diagnostic, maintenance, repair, and other administrative functions for network node 2360.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VOIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IOT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IOT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 2310 includes antenna 2311, interface 2314, processing circuitry 2320, device readable medium 2330, user interface equipment 2332, auxiliary equipment 2334, power source 2336 and power circuitry 2337. WD 2310 may include multiple sets of one or more of the illustrated components for different wireless technologies supported by WD 2310, such as, for example, GSM, WCDMA, LTE, NR, WiFi, WiMAX, or Bluetooth wireless technologies, just to mention a few. These wireless technologies may be integrated into the same or different chips or set of chips as other components within WD 2310.

Antenna 2311 may include one or more antennas or antenna arrays, configured to send and/or receive wireless signals, and is connected to interface 2314. In certain alternative embodiments, antenna 2311 may be separate from WD 2310 and be connectable to WD 2310 through an interface or port. Antenna 2311, interface 2314, and/or processing circuitry 2320 may be configured to perform any receiving or transmitting operations described herein as being performed by a WD. Any information, data and/or signals may be received from a network node and/or another WD. In some embodiments, radio front end circuitry and/or antenna 2311 may be considered an interface.

As illustrated, interface 2314 comprises radio front end circuitry 2312 and antenna 2311. Radio front end circuitry 2312 comprise one or more filters 2318 and amplifiers 2316. Radio front end circuitry 2314 is connected to antenna 2311 and processing circuitry 2320, and is configured to condition signals communicated between antenna 2311 and processing circuitry 2320. Radio front end circuitry 2312 may be coupled to or a part of antenna 2311. In some embodiments, WD 2310 may not include separate radio front end circuitry 2312; rather, processing circuitry 2320 may comprise radio front end circuitry and may be connected to antenna 2311. Similarly, in some embodiments, some or all of RF transceiver circuitry 2322 may be considered a part of interface 2314. Radio front end circuitry 2312 may receive digital data that is to be sent out to other network nodes or WDs via a wireless connection. Radio front end circuitry 2312 may convert the digital data into a radio signal having the appropriate channel and bandwidth parameters using a combination of filters 2318 and/or amplifiers 2316. The radio signal may then be transmitted via antenna 2311. Similarly, when receiving data, antenna 2311 may collect radio signals which are then converted into digital data by radio front end circuitry 2312. The digital data may be passed to processing circuitry 2320. In other embodiments, the interface may comprise different components and/or different combinations of components.

Processing circuitry 2320 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 2310 components, such as device readable medium 2330, WD 2310 functionality. Such functionality may include providing any of the various wireless features or benefits discussed herein. For example, processing circuitry 2320 may execute instructions stored in device readable medium 2330 or in memory within processing circuitry 2320 to provide the functionality disclosed herein.

As illustrated, processing circuitry 2320 includes one or more of RF transceiver circuitry 2322, baseband processing circuitry 2324, and application processing circuitry 2326. In other embodiments, the processing circuitry may comprise different components and/or different combinations of components. In certain embodiments processing circuitry 2320 of WD 2310 may comprise a SOC. In some embodiments, RF transceiver circuitry 2322, baseband processing circuitry 2324, and application processing circuitry 2326 may be on separate chips or sets of chips. In alternative embodiments, part or all of baseband processing circuitry 2324 and application processing circuitry 2326 may be combined into one chip or set of chips, and RF transceiver circuitry 2322 may be on a separate chip or set of chips. In still alternative embodiments, part or all of RF transceiver circuitry 2322 and baseband processing circuitry 2324 may be on the same chip or set of chips, and application processing circuitry 2326 may be on a separate chip or set of chips. In yet other alternative embodiments, part or all of RF transceiver circuitry 2322, baseband processing circuitry 2324, and application processing circuitry 2326 may be combined in the same chip or set of chips. In some embodiments, RF transceiver circuitry 2322 may be a part of interface 2314. RF transceiver circuitry 2322 may condition RF signals for processing circuitry 2320.

In certain embodiments, some or all of the functionality described herein as being performed by a WD may be provided by processing circuitry 2320 executing instructions stored on device readable medium 2330, which in certain embodiments may be a computer-readable storage medium. In alternative embodiments, some or all of the functionality may be provided by processing circuitry 2320 without executing instructions stored on a separate or discrete device readable storage medium, such as in a hard-wired manner. In any of those particular embodiments, whether executing instructions stored on a device readable storage medium or not, processing circuitry 2320 can be configured to perform the described functionality. The benefits provided by such functionality are not limited to processing circuitry 2320 alone or to other components of WD 2310, but are enjoyed by WD 2310 as a whole, and/or by end users and the wireless network generally.

Processing circuitry 2320 may be configured to perform any determining, calculating, or similar operations (e.g., certain obtaining operations) described herein as being performed by a WD. These operations, as performed by processing circuitry 2320, may include processing information obtained by processing circuitry 2320 by, for example, converting the obtained information into other information, comparing the obtained information or converted information to information stored by WD 2310, and/or performing one or more operations based on the obtained information or converted information, and as a result of said processing making a determination.

Device readable medium 2330 may be operable to store a computer program, software, an application including one or more of logic, rules, code, tables, etc. and/or other instructions capable of being executed by processing circuitry 2320. Device readable medium 2330 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 2320. In some embodiments, processing circuitry 2320 and device readable medium 2330 may be considered to be integrated.

User interface equipment 2332 may provide components that allow for a human user to interact with WD 2310. Such interaction may be of many forms, such as visual, audial, tactile, etc. User interface equipment 2332 may be operable to produce output to the user and to allow the user to provide input to WD 2310. The type of interaction may vary depending on the type of user interface equipment 2332 installed in WD 2310. For example, if WD 2310 is a smart phone, the interaction may be via a touch screen; if WD 2310 is a smart meter, the interaction may be through a screen that provides usage (e.g., the number of gallons used) or a speaker that provides an audible alert (e.g., if smoke is detected). User interface equipment 2332 may include input interfaces, devices and circuits, and output interfaces, devices and circuits. User interface equipment 2332 is configured to allow input of information into WD 2310, and is connected to processing circuitry 2320 to allow processing circuitry 2320 to process the input information. User interface equipment 2332 may include, for example, a microphone, a proximity or other sensor, keys/buttons, a touch display, one or more cameras, a USB port, or other input circuitry. User interface equipment 2332 is also configured to allow output of information from WD 2310, and to allow processing circuitry 2320 to output information from WD 2310. User interface equipment 2332 may include, for example, a speaker, a display, vibrating circuitry, a USB port, a headphone interface, or other output circuitry. Using one or more input and output interfaces, devices, and circuits, of user interface equipment 2332, WD 2310 may communicate with end users and/or the wireless network, and allow them to benefit from the functionality described herein.

Auxiliary equipment 2334 is operable to provide more specific functionality which may not be generally performed by WDs. This may comprise specialized sensors for doing measurements for various purposes, interfaces for additional types of communication such as wired communications etc. The inclusion and type of components of auxiliary equipment 2334 may vary depending on the embodiment and/or scenario.

Power source 2336 may, in some embodiments, be in the form of a battery or battery pack. Other types of power sources, such as an external power source (e.g., an electricity outlet), photovoltaic devices or power cells, may also be used. WD 2310 may further comprise power circuitry 2337 for delivering power from power source 2336 to the various parts of WD 2310 which need power from power source 2336 to carry out any functionality described or indicated herein. Power circuitry 2337 may in certain embodiments comprise power management circuitry. Power circuitry 2337 may additionally or alternatively be operable to receive power from an external power source; in which case WD 2310 may be connectable to the external power source (such as an electricity outlet) via input circuitry or an interface such as an electrical power cable. Power circuitry 2337 may also in certain embodiments be operable to deliver power from an external power source to power source 2336. This may be, for example, for the charging of power source 2336. Power circuitry 2337 may perform any formatting, converting, or other modification to the power from power source 2336 to make the power suitable for the respective components of WD 2310 to which power is supplied.

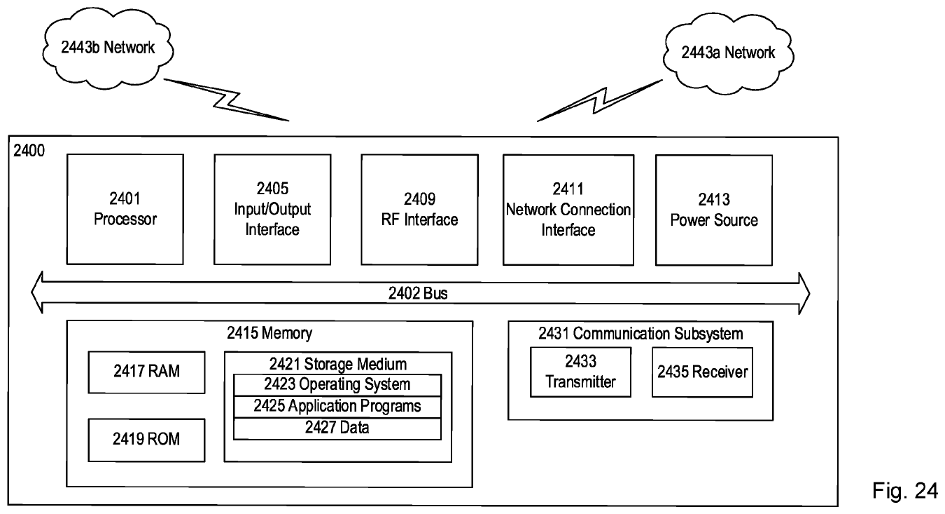

FIG. 24 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 2400 may be any UE identified by the 3rd Generation Partnership Project (3GPP), including a NB-IOT UE, a machine type communication (MTC) UE, and/or an enhanced MTC (eMTC) UE. UE 2400, as illustrated in FIG. 24, is one example of a WD configured for communication in accordance with one or more communication standards promulgated by the 3rd Generation Partnership Project (3GPP), such as 3GPP's GSM, UMTS, LTE, and/or 5G standards. As mentioned previously, the term WD and UE may be used interchangeable. Accordingly, although FIG. 24 is a UE, the components discussed herein are equally applicable to a WD, and vice-versa.

In FIG. 24, UE 2400 includes processing circuitry 2401 that is operatively coupled to input/output interface 2405, radio frequency (RF) interface 2409, network connection interface 2411, memory 2415 including random access memory (RAM) 2417, read-only memory (ROM) 2419, and storage medium 2421 or the like, communication subsystem 2431, power source 2433, and/or any other component, or any combination thereof. Storage medium 2421 includes operating system 2423, application program 2425, and data 2427. In other embodiments, storage medium 2421 may include other similar types of information. Certain UEs may utilize all of the components shown in FIG. 24, or only a subset of the components. The level of integration between the components may vary from one UE to another UE. Further, certain UEs may contain multiple instances of a component, such as multiple processors, memories, transceivers, transmitters, receivers, etc.

In FIG. 24, processing circuitry 2401 may be configured to process computer instructions and data. Processing circuitry 2401 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 2401 may include two central processing units (CPUs). Data may be information in a form suitable for use by a computer.

In the depicted embodiment, input/output interface 2405 may be configured to provide a communication interface to an input device, output device, or input and output device. UE 2400 may be configured to use an output device via input/output interface 2405. An output device may use the same type of interface port as an input device. For example, a USB port may be used to provide input to and output from UE 2400. The output device may be a speaker, a sound card, a video card, a display, a monitor, a printer, an actuator, an emitter, a smartcard, another output device, or any combination thereof. UE 2400 may be configured to use an input device via input/output interface 2405 to allow a user to capture information into UE 2400. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 24, RF interface 2409 may be configured to provide a communication interface to RF components such as a transmitter, a receiver, and an antenna. Network connection interface 2411 may be configured to provide a communication interface to network 2443a. Network 2443a may encompass wired and/or wireless networks such as a local-area network (LAN), a wide-area network (WAN), a computer network, a wireless network, a telecommunications network, another like network or any combination thereof. For example, network 2443a may comprise a Wi-Fi network. Network connection interface 2411 may be configured to include a receiver and a transmitter interface used to communicate with one or more other devices over a communication network according to one or more communication protocols, such as Ethernet, TCP/IP, SONET, ATM, or the like. Network connection interface 2411 may implement receiver and transmitter functionality appropriate to the communication network links (e.g., optical, electrical, and the like). The transmitter and receiver functions may share circuit components, software or firmware, or alternatively may be implemented separately.

RAM 2417 may be configured to interface via bus 2402 to processing circuitry 2401 to provide storage or caching of data or computer instructions during the execution of software programs such as the operating system, application programs, and device drivers. ROM 2419 may be configured to provide computer instructions or data to processing circuitry 2401. For example, ROM 2419 may be configured to store invariant low-level system code or data for basic system functions such as basic input and output (I/O), startup, or reception of keystrokes from a keyboard that are stored in a non-volatile memory. Storage medium 2421 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 2421 may be configured to include operating system 2423, application program 2425 such as a web browser application, a widget or gadget engine or another application, and data file 2427. Storage medium 2421 may store, for use by UE 2400, any of a variety of various operating systems or combinations of operating systems.

Storage medium 2421 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 2421 may allow UE 2400 to access computer-executable instructions, application programs or the like, stored on transitory or non-transitory memory media, to off-load data, or to upload data. An article of manufacture, such as one utilizing a communication system may be tangibly embodied in storage medium 2421, which may comprise a device readable medium.

In FIG. 24, processing circuitry 2401 may be configured to communicate with network 2443b using communication subsystem 2431. Network 2443a and network 2443b may be the same network or networks or different network or networks. Communication subsystem 2431 may be configured to include one or more transceivers used to communicate with network 2443b. For example, communication subsystem 2431 may be configured to include one or more transceivers used to communicate with one or more remote transceivers of another device capable of wireless communication such as another WD, UE, or base station of a radio access network (RAN) according to one or more communication protocols, such as IEEE 802.11, CDMA, WCDMA, GSM, LTE, UTRAN, WiMax, or the like. Each transceiver may include transmitter 2433 and/or receiver 2435 to implement transmitter or receiver functionality, respectively, appropriate to the RAN links (e.g., frequency allocations and the like). Further, transmitter 2433 and receiver 2435 of each transceiver may share circuit components, software or firmware, or alternatively may be implemented separately.

In the illustrated embodiment, the communication functions of communication subsystem 2431 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 2431 may include cellular communication, Wi-Fi communication, Bluetooth communication, and GPS communication. Network 2443b may encompass wired and/or wireless networks such as a local-area network (LAN), a wide-area network (WAN), a computer network, a wireless network, a telecommunications network, another like network or any combination thereof. For example, network 2443b may be a cellular network, a Wi-Fi network, and/or a near-field network. Power source 2413 may be configured to provide alternating current (AC) or direct current (DC) power to components of UE 2400.

The features, benefits and/or functions described herein may be implemented in one of the components of UE 2400 or partitioned across multiple components of UE 2400. Further, the features, benefits, and/or functions described herein may be implemented in any combination of hardware, software or firmware. In one example, communication subsystem 2431 may be configured to include any of the components described herein. Further, processing circuitry 2401 may be configured to communicate with any of such components over bus 2402. In another example, any of such components may be represented by program instructions stored in memory that when executed by processing circuitry 2401 perform the corresponding functions described herein. In another example, the functionality of any of such components may be partitioned between processing circuitry 2401 and communication subsystem 2431. In another example, the non-computationally intensive functions of any of such components may be implemented in software or firmware and the computationally intensive functions may be implemented in hardware.

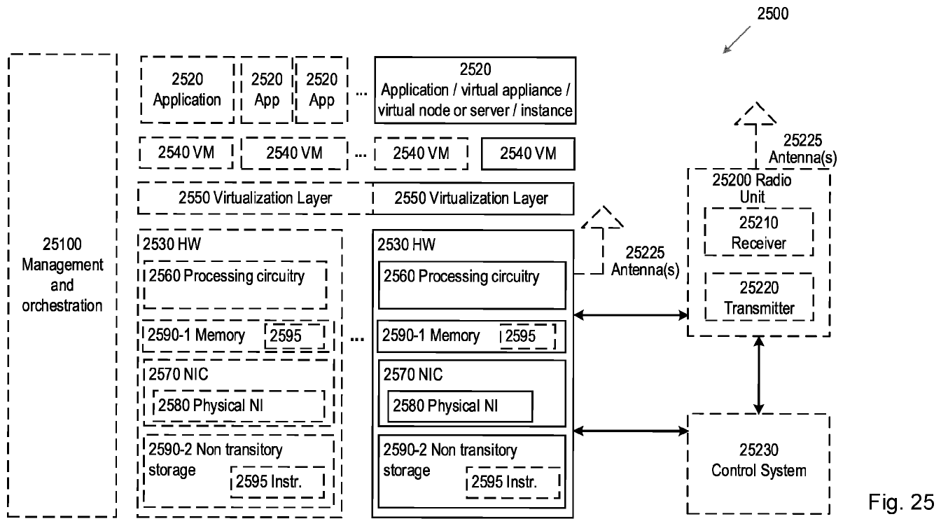

FIG. 25 is a schematic block diagram illustrating a virtualization environment 2500 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 2500 hosted by one or more of hardware nodes 2530. Further, in embodiments in which the virtual node is not a radio access node or does not require radio connectivity (e.g., a core network node), then the network node may be entirely virtualized.

The functions may be implemented by one or more applications 2520 (which may alternatively be called software instances, virtual appliances, network functions, virtual nodes, virtual network functions, etc.) operative to implement some of the features, functions, and/or benefits of some of the embodiments disclosed herein. Applications 2520 are run in virtualization environment 2500 which provides hardware 2530 comprising processing circuitry 2560 and memory 2590. Memory 2590 contains instructions 2595 executable by processing circuitry 2560 whereby application 2520 is operative to provide one or more of the features, benefits, and/or functions disclosed herein.

Virtualization environment 2500, comprises general-purpose or special-purpose network hardware devices 2530 comprising a set of one or more processors or processing circuitry 2560, which may be commercial off-the-shelf (COTS) processors, dedicated Application Specific Integrated Circuits (ASICs), or any other type of processing circuitry including digital or analog hardware components or special purpose processors. Each hardware device may comprise memory 2590-1 which may be non-persistent memory for temporarily storing instructions 2595 or software executed by processing circuitry 2560. Each hardware device may comprise one or more network interface controllers (NICs) 2570, also known as network interface cards, which include physical network interface 2580. Each hardware device may also include non-transitory, persistent, machine-readable storage media 2590-2 having stored therein software 2595 and/or instructions executable by processing circuitry 2560. Software 2595 may include any type of software including software for instantiating one or more virtualization layers 2550 (also referred to as hypervisors), software to execute virtual machines 2540 as well as software allowing it to execute functions, features and/or benefits described in relation with some embodiments described herein.

Virtual machines 2540, comprise virtual processing, virtual memory, virtual networking or interface and virtual storage, and may be run by a corresponding virtualization layer 2550 or hypervisor. Different embodiments of the instance of virtual appliance 2520 may be implemented on one or more of virtual machines 2540, and the implementations may be made in different ways.

During operation, processing circuitry 2560 executes software 2595 to instantiate the hypervisor or virtualization layer 2550, which may sometimes be referred to as a virtual machine monitor (VMM). Virtualization layer 2550 may present a virtual operating platform that appears like networking hardware to virtual machine 2540. As shown in FIG. 25, hardware 2530 may be a standalone network node with generic or specific components. Hardware 2530 may comprise antenna 25225 and may implement some functions via virtualization. Alternatively, hardware 2530 may be part of a larger cluster of hardware (e.g. such as in a data center or customer premise equipment (CPE)) where many hardware nodes work together and are managed via management and orchestration (MANO) 25100, which, among others, oversees lifecycle management of applications 2520.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 2540 may be a software implementation of a physical machine that runs programs as if they were executing on a physical, non-virtualized machine. Each of virtual machines 2540, and that part of hardware 2530 that executes that virtual machine, be it hardware dedicated to that virtual machine and/or hardware shared by that virtual machine with others of the virtual machines 2540, forms a separate virtual network elements (VNE).

Still in the context of NFV, Virtual Network Function (VNF) is responsible for handling specific network functions that run in one or more virtual machines 2540 on top of hardware networking infrastructure 2530 and corresponds to application 2520 in FIG. 25.

In some embodiments, one or more radio units 25200 that each include one or more transmitters 25220 and one or more receivers 25210 may be coupled to one or more antennas 25225. Radio units 25200 may communicate directly with hardware nodes 2530 via one or more appropriate network interfaces and may be used in combination with the virtual components to provide a virtual node with radio capabilities, such as a radio access node or a base station.

In some embodiments, some signalling can be effected with the use of control system 25230 which may alternatively be used for communication between the hardware nodes 2530 and radio units 25200.

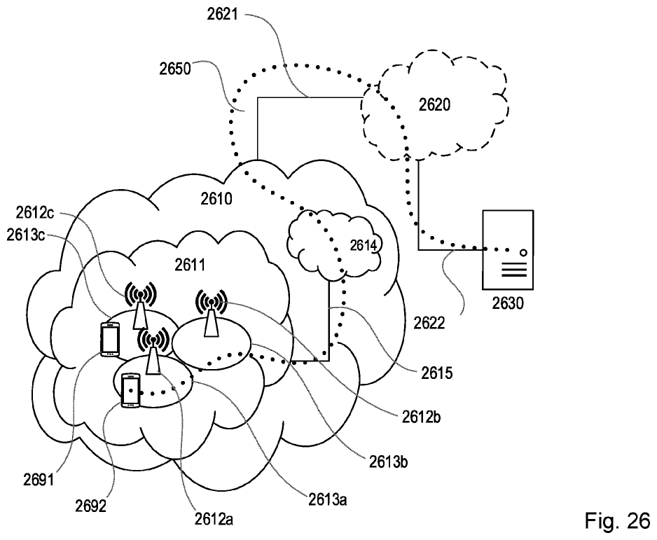

With reference to FIG. 26, in accordance with an embodiment, a communication system includes telecommunication network 2610, such as a 3GPP-type cellular network, which comprises access network 2611, such as a radio access network, and core network 2614. Access network 2611 comprises a plurality of base stations 2612a, 2612b, 2612c, such as NBs, eNBs, gNBs or other types of wireless access points, each defining a corresponding coverage area 2613a, 2613b, 2613c. Each base station 2612a, 2612b, 2612c is connectable to core network 2614 over a wired or wireless connection 2615. A first UE 2691 located in coverage area 2613c is configured to wirelessly connect to, or be paged by, the corresponding base station 2612c. A second UE 2692 in coverage area 2613a is wirelessly connectable to the corresponding base station 2612a. While a plurality of UEs 2691, 2692 are illustrated in this example, the disclosed embodiments are equally applicable to a situation where a sole UE is in the coverage area or where a sole UE is connecting to the corresponding base station 2612.

Telecommunication network 2610 is itself connected to host computer 2630, which may be embodied in the hardware and/or software of a standalone server, a cloud-implemented server, a distributed server or as processing resources in a server farm. Host computer 2630 may be under the ownership or control of a service provider, or may be operated by the service provider or on behalf of the service provider. Connections 2621 and 2622 between telecommunication network 2610 and host computer 2630 may extend directly from core network 2614 to host computer 2630 or may go via an optional intermediate network 2620. Intermediate network 2620 may be one of, or a combination of more than one of, a public, private or hosted network; intermediate network 2620, if any, may be a backbone network or the Internet; in particular, intermediate network 2620 may comprise two or more sub-networks (not shown).

The communication system of FIG. 26 as a whole enables connectivity between the connected UEs 2691, 2692 and host computer 2630. The connectivity may be described as an over-the-top (OTT) connection 2650. Host computer 2630 and the connected UEs 2691, 2692 are configured to communicate data and/or signaling via OTT connection 2650, using access network 2611, core network 2614, any intermediate network 2620 and possible further infrastructure (not shown) as intermediaries. OTT connection 2650 may be transparent in the sense that the participating communication devices through which OTT connection 2650 passes are unaware of routing of uplink and downlink communications. For example, base station 2612 may not or need not be informed about the past routing of an incoming downlink communication with data originating from host computer 2630 to be forwarded (e.g., handed over) to a connected UE 2691. Similarly, base station 2612 need not be aware of the future routing of an outgoing uplink communication originating from the UE 2691 towards the host computer 2630.

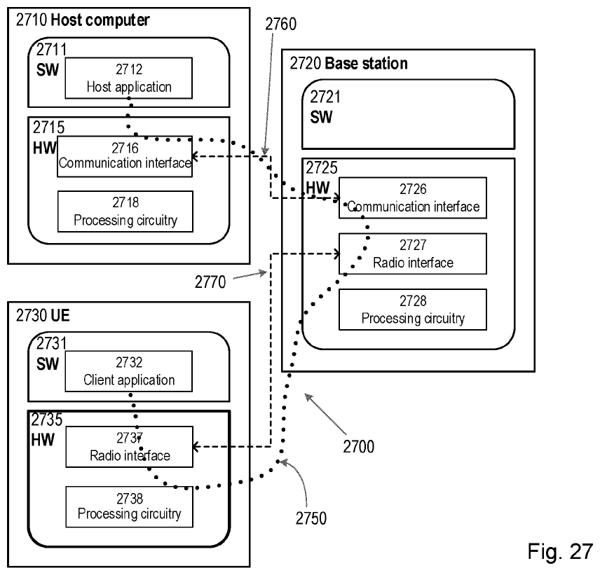

Example implementations, in accordance with an embodiment, of the UE, base station and host computer discussed in the preceding paragraphs will now be described with reference to FIG. 27. In communication system 2700, host computer 2710 comprises hardware 2715 including communication interface 2716 configured to set up and maintain a wired or wireless connection with an interface of a different communication device of communication system 2700. Host computer 2710 further comprises processing circuitry 2718, which may have storage and/or processing capabilities. In particular, processing circuitry 2718 may comprise one or more programmable processors, application-specific integrated circuits, field programmable gate arrays or combinations of these (not shown) adapted to execute instructions. Host computer 2710 further comprises software 2711, which is stored in or accessible by host computer 2710 and executable by processing circuitry 2718. Software 2711 includes host application 2712. Host application 2712 may be operable to provide a service to a remote user, such as UE 2730 connecting via OTT connection 2750 terminating at UE 2730 and host computer 2710. In providing the service to the remote user, host application 2712 may provide user data which is transmitted using OTT connection 2750.

Communication system 2700 further includes base station 2720 provided in a telecommunication system and comprising hardware 2725 enabling it to communicate with host computer 2710 and with UE 2730. Hardware 2725 may include communication interface 2726 for setting up and maintaining a wired or wireless connection with an interface of a different communication device of communication system 2700, as well as radio interface 2727 for setting up and maintaining at least wireless connection 2770 with UE 2730 located in a coverage area (not shown in FIG. 27) served by base station 2720. Communication interface 2726 may be configured to facilitate connection 2760 to host computer 2710. Connection 2760 may be direct or it may pass through a core network (not shown in FIG. 27) of the telecommunication system and/or through one or more intermediate networks outside the telecommunication system. In the embodiment shown, hardware 2725 of base station 2720 further includes processing circuitry 2728, which may comprise one or more programmable processors, application-specific integrated circuits, field programmable gate arrays or combinations of these (not shown) adapted to execute instructions. Base station 2720 further has software 2721 stored internally or accessible via an external connection.

Communication system 2700 further includes UE 2730 already referred to. Its hardware 2735 may include radio interface 2737 configured to set up and maintain wireless connection 2770 with a base station serving a coverage area in which UE 2730 is currently located. Hardware 2735 of UE 2730 further includes processing circuitry 2738, which may comprise one or more programmable processors, application-specific integrated circuits, field programmable gate arrays or combinations of these (not shown) adapted to execute instructions. UE 2730 further comprises software 2731, which is stored in or accessible by UE 2730 and executable by processing circuitry 2738. Software 2731 includes client application 2732. Client application 2732 may be operable to provide a service to a human or non-human user via UE 2730, with the support of host computer 2710. In host computer 2710, an executing host application 2712 may communicate with the executing client application 2732 via OTT connection 2750 terminating at UE 2730 and host computer 2710. In providing the service to the user, client application 2732 may receive request data from host application 2712 and provide user data in response to the request data. OTT connection 2750 may transfer both the request data and the user data. Client application 2732 may interact with the user to generate the user data that it provides.

It is noted that host computer 2710, base station 2720 and UE 2730 illustrated in FIG. 27 may be similar or identical to host computer 2630, one of base stations 2612a, 2612b, 2612c and one of UEs 2691, 2692 of FIG. 26, respectively. This is to say, the inner workings of these entities may be as shown in FIG. 27 and independently, the surrounding network topology may be that of FIG. 26.

In FIG. 27, OTT connection 2750 has been drawn abstractly to illustrate the communication between host computer 2710 and UE 2730 via base station 2720, without explicit reference to any intermediary devices and the precise routing of messages via these devices. Network infrastructure may determine the routing, which it may be configured to hide from UE 2730 or from the service provider operating host computer 2710, or both. While OTT connection 2750 is active, the network infrastructure may further take decisions by which it dynamically changes the routing (e.g., on the basis of load balancing consideration or reconfiguration of the network).

Wireless connection 2770 between UE 2730 and base station 2720 is in accordance with the teachings of the embodiments described throughout this disclosure. One or more of the various embodiments improve the performance of OTT services provided to UE 2730 using OTT connection 2750, in which wireless connection 2770 forms the last segment. More precisely, the teachings of these embodiments may improve the traffic and resource management in the radio access network and thereby provide benefits such as reduced user waiting time, relaxed restriction on file sizes, better responsiveness, improved user experience, etc.

A measurement procedure may be provided for the purpose of monitoring data rate, latency and other factors on which the one or more embodiments improve. There may further be an optional network functionality for reconfiguring OTT connection 2750 between host computer 2710 and UE 2730, in response to variations in the measurement results. The measurement procedure and/or the network functionality for reconfiguring OTT connection 2750 may be implemented in software 2711 and hardware 2715 of host computer 2710 or in software 2731 and hardware 2735 of UE 2730, or both. In embodiments, sensors (not shown) may be deployed in or in association with communication devices through which OTT connection 2750 passes; the sensors may participate in the measurement procedure by supplying values of the monitored quantities exemplified above, or supplying values of other physical quantities from which software 2711, 2731 may compute or estimate the monitored quantities. The reconfiguring of OTT connection 2750 may include message format, retransmission settings, preferred routing etc.; the reconfiguring need not affect base station 2720, and it may be unknown or imperceptible to base station 2720. Such procedures and functionalities may be known and practiced in the art. In certain embodiments, measurements may involve proprietary UE signaling facilitating host computer 2710's measurements of throughput, propagation times, latency and the like. The measurements may be implemented in that software 2711 and 2731 causes messages to be transmitted, in particular empty or ‘dummy’ messages, using OTT connection 2750 while it monitors propagation times, errors etc.

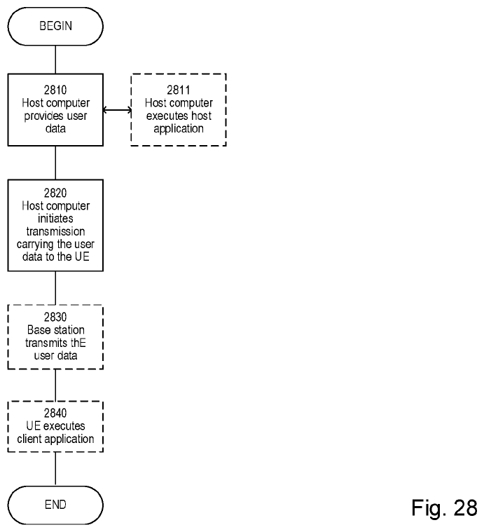

FIG. 28 is a flowchart illustrating a method implemented in a communication system, in accordance with one embodiment. The communication system includes a host computer, a base station and a UE which may be those described with reference to FIGS. 26 and 27. For simplicity of the present disclosure, only drawing references to FIG. 28 will be included in this section. In step 2810, the host computer provides user data. In substep 2811 (which may be optional) of step 2810, the host computer provides the user data by executing a host application.

In step 2820, the host computer initiates a transmission carrying the user data to the UE. In step 2830 (which may be optional), the base station transmits to the UE the user data which was carried in the transmission that the host computer initiated, in accordance with the teachings of the embodiments described throughout this disclosure. In step 2840 (which may also be optional), the UE executes a client application associated with the host application executed by the host computer.

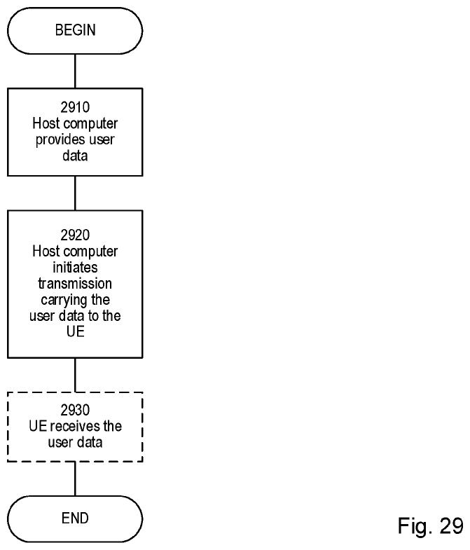

FIG. 29 is a flowchart illustrating a method implemented in a communication system, in accordance with one embodiment. The communication system includes a host computer, a base station and a UE which may be those described with reference to FIGS. 26 and 27. For simplicity of the present disclosure, only drawing references to FIG. 29 will be included in this section. In step 2910 of the method, the host computer provides user data. In an optional substep (not shown) the host computer provides the user data by executing a host application. In step 2920, the host computer initiates a transmission carrying the user data to the UE. The transmission may pass via the base station, in accordance with the teachings of the embodiments described throughout this disclosure. In step 2930 (which may be optional), the UE receives the user data carried in the transmission.

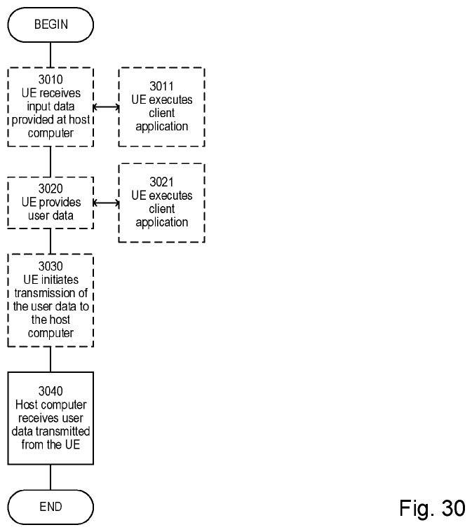

FIG. 30 is a flowchart illustrating a method implemented in a communication system, in accordance with one embodiment. The communication system includes a host computer, a base station and a UE which may be those described with reference to FIGS. 26 and 27. For simplicity of the present disclosure, only drawing references to FIG. 30 will be included in this section. In step 3010 (which may be optional), the UE receives input data provided by the host computer. Additionally or alternatively, in step 3020, the UE provides user data. In substep 3021 (which may be optional) of step 3020, the UE provides the user data by executing a client application. In substep 3011 (which may be optional) of step 3010, the UE executes a client application which provides the user data in reaction to the received input data provided by the host computer. In providing the user data, the executed client application may further consider user input received from the user. Regardless of the specific manner in which the user data was provided, the UE initiates, in substep 3030 (which may be optional), transmission of the user data to the host computer. In step 3040 of the method, the host computer receives the user data transmitted from the UE, in accordance with the teachings of the embodiments described throughout this disclosure.

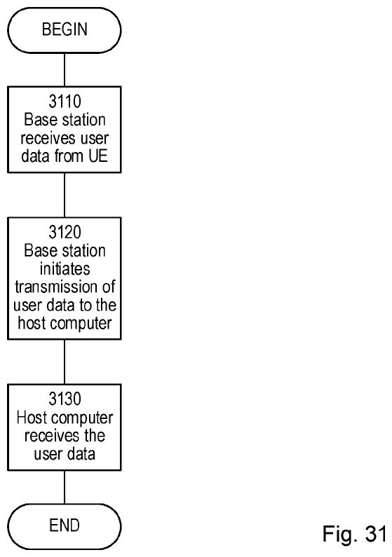

FIG. 31 is a flowchart illustrating a method implemented in a communication system, in accordance with one embodiment. The communication system includes a host computer, a base station and a UE which may be those described with reference to FIGS. 26 and 27. For simplicity of the present disclosure, only drawing references to FIG. 31 will be included in this section. In step 3110 (which may be optional), in accordance with the teachings of the embodiments described throughout this disclosure, the base station receives user data from the UE. In step 3120 (which may be optional), the base station initiates transmission of the received user data to the host computer. In step 3130 (which may be optional), the host computer receives the user data carried in the transmission initiated by the base station.

The methods of the present disclosure may be implemented in hardware, or as software modules running on one or more processors. The methods may also be carried out according to the instructions of a computer program, and the present disclosure also provides a computer readable medium having stored thereon a program for carrying out any of the methods described herein. A computer program embodying the disclosure may be stored on a computer readable medium, or it could, for example, be in the form of a signal such as a downloadable data signal provided from an Internet website, or it could be in any other form.

It should be noted that the above-mentioned examples illustrate rather than limit the disclosure, and that those skilled in the art will be able to design many alternative embodiments without departing from the scope of the appended claims or embodiments. The word “comprising” does not exclude the presence of elements or steps other than those listed in a claim or embodiment, “a” or “an” does not exclude a plurality, and a single processor or other unit may fulfil the functions of several units recited in the claims or embodiments. Any reference signs in the claims or embodiments shall not be construed so as to limit their scope.

The following are certain enumerated embodiments further illustrating various aspects the disclosed subject matter.

1. A computer implemented method (400) for managing resources in a Radio Access Network, RAN, of a communication network, the method, performed by a first node in the RAN, comprising:
obtaining a record of resource status information describing usage, during a historical time period, of RAN resources controlled by a second node in the RAN (420);
predicting, based on the obtained record, resource status information describing usage of RAN resources controlled by the second node during a future time period (430); and
   performing at least one of:
using the predicted resource status information describing usage of RAN resources controlled by the second node in a process relating to management of RAN resources controlled by the first node (440); or
sending, to a third node in the RAN, a representation of the predicted resource status information describing usage of RAN resources controlled by the second node (450).

2. The method of embodiment 1, wherein resource status information (701) describing usage of RAN resources controlled by the second node comprises at least one of the metrics:
number of active wireless devices served by the second node; (701a)
Quality of Experience measure (701b);
Quality of Service measure (701c);
established Radio Resource Control, RRC, Connections (701d);
available RRC Connection capacity (701e);
number of inactive UE contexts for wireless devices stored by the second node (701f);
Radio Resource Status (701g);
available Transport Network Layer resources (701h);
capacity available over a specific radio coverage area of the second node, in uplink and/or downlink (701i);
Slice Available Capacity, in uplink and/or downlink (701j);
traffic for each served wireless device (701k);
size of data arrival in uplink or downlink for a wireless device within a time period (7011);
resource use in a part of the coverage area of the second node that is adjacent a coverage area of another node (701m); and/or
transmission power used per resource block in uplink and/or downlink (701n).

3. The method of embodiment 2, wherein predicted resource status information describing predicted usage of RAN resources controlled by the second node comprises at least one of:
any one or more of the metrics listed in embodiment 2 (721a);
a time window for which the predicted resource status information is valid (721b); and/or
a measure of uncertainty, accuracy and/or confidence interval for the predicted resource status information (721c).

4. The method of embodiment 2 or 3, wherein resource status information and predicted resource status information are assembled according to at least one of the criteria:
per uplink/downlink (721i);
per cell (721ii);
per Data Radio Bearer (721iii);
per 5G Quality of Service Indicator (721iv);
per Quality of Service Class Indicator (721v);
per intra cell coverage area (721vi);
per network slice (721vii);
maximum, minimum, mean, average, median (721viii);
per sharing PLMN (721ix).

5. The method of any one of embodiments 1 to 4, wherein predicting, based on the obtained record, resource status information describing usage of RAN resources controlled by the second node during a future time period comprises:
predicting resource status information describing usage of RAN resources controlled by the second node during a future time period based on the obtained record and on at least one of (730b):
a record of resource status information describing usage, during a historical time period, of RAN resources controlled by the first node;
a record of resource status information describing usage, during a historical time period, of RAN resources controlled by the third node;
previously predicted resource status information describing usage of RAN resources controlled by the first node during a future or historical time period;
previously predicted resource status information describing usage of RAN resources controlled by the second node during a future or historical time period;
previously predicted resource status information describing usage of RAN resources controlled by the third node during a future or historical time period.

6. The method of any one of embodiments 1 to 5, wherein obtaining a record of resource status information describing usage, during a historical time period, of RAN resources controlled by a second node in the RAN comprises:
receiving the record of resource status information in a message from the second node (720).

7. The method of any one of embodiments 1 to 6, further comprising sending to the second node a request for the record of resource status information (704).

8. The method of embodiment 7, further comprising:
receiving from the second node an acknowledgment of the request (706).

9 The method of embodiment 8, wherein the acknowledgement indicates at least one of (706a):
an extent to which resource status information metrics specified in the request sent by the first node can be provided by the second node;
an extent to which a reporting configuration specified in the request sent by the first node will be respected by the second node.

10. The method of any one of embodiments 1 to 9, further comprising:
receiving from the third node a request for a representation of predicted resource status information describing usage of RAN resources controlled by the second node (702).

11. The method of embodiment 10, when dependent on embodiment 7, wherein sending to the second node a request for the record of resource status information comprises:
sending to the second node the request for the record of resource status information responsive to receiving from the third node the request for a representation of predicted resource status information describing usage of RAN resources controlled by the second node (704a).

12. The method of embodiment 10 or 11, wherein the request for a representation of predicted resource status information describing usage of RAN resources controlled by the second node comprises:
a list of cells served by the second node and for which prediction of resource status information metrics is requested (702a).

13. The method of any one of embodiments 10 to 12, wherein the request for a representation of predicted resource status information describing usage of RAN resources controlled by the second node comprises at least one of (702b):
a specification of resource status information metrics to be predicted;
a requested granularity of prediction;
a part of the communication network for which prediction is requested;
a reporting configuration for providing the requested representation.

14 The method of embodiment 13, wherein the specification of resource status information metrics to be predicted comprise any one or more of the metrics listed in embodiment 2 or embodiment 3 (702c).

15. The method of any one of embodiments 10 to 14, further comprising:

sending to the third node an acknowledgement of the request for a representation of predicted resource status information describing usage of RAN resources controlled by the second node (710).

16. The method of embodiment 15, when dependent on embodiment 8 or 9, further comprising:
determining, based on the acknowledgment received from the second node, an extent to which the representation of predicted resource status information describing usage of RAN resources controlled by the second node, requested by the third node, can be provided (708); and
including in the acknowledgement to the third node at least one of (710a):
   the determined extent to which the representation of predicted resource status information describing usage of RAN resources controlled by the second node, requested by the third node, can be provided;
   an extent to which a reporting configuration specified in the request sent by the third node will be respected by the first node.

17. The method of any one of embodiments 1 to 16, wherein sending, to the third node, a representation of the predicted resource status information describing usage of RAN resources controlled by the second node comprises:
sending the representation on fulfillment of a trigger condition comprising at least one of a timer or a threshold for a predicted metric (732).

18. The method of any one of embodiments 1 to 17, wherein the representation of the predicted resource status information describing usage of RAN resources controlled by the second node comprises a change from a previously predicted value of a resource status information metric (740a).

19. The method of any one of embodiments 1 to 17, further comprising:
sending the representation of the predicted resource status information describing usage of RAN resources controlled by the second node to the second node. (760)

20. The method of any one of embodiments 1 to 18, further comprising:
obtaining, from the second node, a record of resource status information describing usage, during the future time period, of RAN resources controlled by the second node (770); and
comparing the obtained record of resource status information to the predicted resource status information (780).

21. The method of embodiment 20, further comprising:
updating, based on the comparison, a process for predicting resource status information describing usage of RAN resources controlled by the second node (790).

22. The method of any one of embodiments 1 to 21, wherein predicting, based on the obtained record, resource status information describing usage of RAN resources controlled by the second node and during a future time period comprises using a Machine Learning, ML, process to predict the resource status information (730).

23. The method of any embodiment 22, wherein using an ML process to predict, based on the obtained record, resource status information describing usage of RAN resources controlled by the second node and during a future time period comprises using at least one of (730a):
an Autoregressive model;
a Feedforward Neural Network;
a Convolutional Neural Network;
a graph-based Neural Network;
a Recurrent Neural Network; or
a Long Short-Term Memory process
to predict the resource status information.

24. The method of any one of embodiments 1 to 23, wherein the second node is a neighbor of the first node, such that a signaling connection is established between the first node and second node (704b).

25. The method of any one of embodiments 1 to 24, wherein using the predicted resource status information describing usage of RAN resources controlled by the second node in a process relating to management of RAN resources controlled by the first node comprises:
inputting the received representation of predicted resource status information for RAN resources controlled by the second node to a resource optimization process (750a).

26. The method of any one of embodiments 1 to 25, wherein at least one of the first, second or third nodes comprises at least one of:
eNB;
ng-eNB;
eNB-CU;
eNB-DU;
eNB-CU-UP;
eNB-CU-CP;
   gNB;
   en-gNB;
   gNB-CU;
   gNB-DU;
   gNB-CU-UP;
   gNB-CU-CP;
IAB-node,
IAB-donor DU;
IAB-donor CU;
IAB-DU;
O-CU;
O-CU-CP;
O-DU or
O-eNB.

27. A computer implemented method (500) for managing resources in a Radio Access Network, RAN, of a communication network, the method, performed by a third node in the RAN, comprising:
receiving, from a first node in the RAN, a representation of predicted resource status information describing usage of RAN resources controlled by a second node in the RAN during a future time period (510); and
using the predicted resource status information describing usage of RAN resources controlled by the second node in a process relating to management of RAN resources controlled by the third node (520).

28. The method of embodiment 27, wherein predicted resource status information describing predicted usage of RAN resources controlled by the second node comprises at least one of:
number of active wireless devices served by the second node; (701a)
Quality of Experience measure (701b);
Quality of Service measure (701c);
established Radio Resource Control, RRC, Connections (701d);
available RRC Connection capacity (701e);
number of inactive UE contexts for wireless devices stored by the second node (701f);
Radio Resource Status (701g);
available Transport Network Layer resources (701h);
capacity available over a specific radio coverage area of the second node, in uplink and/or downlink (701i); Slice Available Capacity, in uplink and/or downlink (701j);
traffic for each served wireless device (701k);
size of data arrival in uplink or downlink for a wireless device within a time period (7011);
resource use in a part of the coverage area of the second node that is adjacent a coverage area of another node (701m); and/or
transmission power used per resource block in uplink and/or downlink (701n).

29. The method of embodiment 28, wherein the predicted resource status information is assembled according to at least one of the criteria:
per uplink/downlink (721i);
per cell (721ii);
per Data Radio Bearer (721iii);
per 5G Quality of Service Indicator (721iv);
per Quality of Service Class Indicator (721v);
per intra cell coverage area (721vi);
per network slice (721vii);
maximum, minimum, mean, average, median (721viii);
per sharing PLMN (721ix).

30. The method of any one of embodiments 27 to 29, further comprising:
sending to the first node a request for the representation of predicted resource status information describing usage of RAN resources controlled by the second node (804).

31. The method of embodiment 30, wherein the request for a representation of predicted resource status information describing usage of RAN resources controlled by the second node comprises:
a list of cells served by the second node and for which prediction of resource status information metrics is requested (804b).

32. The method of embodiment 31, further comprising:
identifying cells served by the second node which fulfil a criterion for obtaining a predicted resource status information (802).

33. The method of any one of embodiments 30 to 32, wherein the request for a representation of predicted resource status information describing usage of RAN resources controlled by the second node comprises at least one of (804c):
a specification of resource status information metrics to be predicted;
a requested granularity of prediction;
a part of the communication network for which prediction is requested;
a reporting configuration for providing the requested representation.

34 The method of embodiment 33, wherein the specification of resource status information metrics to be predicted comprise any one or more of the metrics listed in embodiment 28 (804d).

35. The method of any one of embodiments 30 to 34, further comprising:
receiving from the first node an acknowledgement of the request for a representation of predicted resource status information describing usage of RAN resources controlled by the second node (806).

36. The method of embodiment 35, wherein the acknowledgement includes at least one of (806a):
an extent to which the representation of predicted resource status information describing usage of RAN resources controlled by the second node, requested by the third node, can be provided by the first node;
an extent to which a reporting configuration specified in the request sent by the third node will be respected by the first node.

37. The method of any one of embodiments 27 to 36, wherein the representation of the predicted resource status information describing usage of RAN resources controlled by the second node comprises a change from a previously predicted value of a resource status information metric (810a).

38. The method of any one of embodiments 27 to 37, wherein the second node is a neighbor of the first node, such that a signaling connection is established between the first node and second node (804a).

39. The method of any one of embodiments 27 to 38, wherein using the predicted resource status information describing usage of RAN resources controlled by the second node in a process relating to management of RAN resources controlled by the third node comprises:
inputting the received representation of predicted resource status information for RAN resources controlled by the second node to a resource optimization process (820a).

40. The method of any one of embodiments 27 to 39, wherein at least one of the first, second or third nodes comprises at least one of:
eNB;
ng-eNB;
eNB-CU;
eNB-DU;
eNB-CU-UP;
eNB-CU-CP;
   gNB;
   en-gNB;
   gNB-CU;
   gNB-DU;
   gNB-CU-UP;
   gNB-CU-CP;
IAB-node,
IAB-donor DU;
IAB-donor CU;
IAB-DU;
O-CU;
O-CU-CP;
O-DU or
O-eNB.

41. The method of any of the previous embodiments, further comprising:
obtaining user data; and
forwarding the user data to a host computer or a wireless device.

42. A computer program product comprising a computer readable medium, the computer readable medium having computer readable code embodied therein, the computer readable code being configured such that, on execution by a suitable computer or processor, the computer or processor is caused to perform a method as claimed in any one of claims 1 to 41.

43. A first node (1900) in a communication network comprising a Radio Access Network, RAN, the first node being configured to manage resources in the Radio Access Network, RAN, whereby the first node is configured to:
obtain a record of resource status information describing usage, during a historical time period, of RAN resources controlled by a second node in the RAN;
predict, based on the obtained record, resource status information describing usage of RAN resources controlled by the second node during a future time period; and
   perform at least one of:
using the predicted resource status information describing usage of RAN resources controlled by the second node in a process relating to management of RAN resources controlled by the first node; or
sending, to a third node in the RAN, a representation of the predicted resource status information describing usage of RAN resources controlled by the second node.

44. The first node of embodiment 43, wherein the first node is further configured to perform the steps of any one of embodiments 2 to 26 or 41.

45. A third node (2100) in a communication network comprising a Radio Access Network, RAN, the third node being configured to manage resources in the Radio Access Network, RAN, whereby the third node is configured to:
receive, from a first node in the RAN, a representation of predicted resource status information describing usage of RAN resources controlled by a second node in the RAN during a future time period; and
use the predicted resource status information describing usage of RAN resources controlled by the second node in a process relating to management of RAN resources controlled by the third node.

46. The third node of embodiment 45, wherein the third node is further configured to perform the steps of any one of embodiments 28 to 41.

47. A first node for managing resources in a Radio Access Network, RAN, of a communication network, the first node comprising:
processing circuitry configured to perform any of the steps of any of embodiments 1 to 26 and 41; and
power supply circuitry configured to supply power to the first node.

48. A second node for managing resources in a Radio Access Network, RAN, of a communication network, the second node comprising:
processing circuitry configured to perform any of the steps of any of embodiments 27 to 41;
power supply circuitry configured to supply power to the second node.

49. A communication system including a host computer comprising:
processing circuitry configured to provide user data; and
a communication interface configured to forward the user data to a cellular network for transmission to a user equipment (UE),
wherein the cellular network comprises a radio access node having a radio interface and processing circuitry, the radio access node's processing circuitry configured to perform any of the steps of any of embodiments 1 to 41.

50. The communication system of the previous embodiment further including the radio access node.

51. The communication system of the previous 2 embodiments, further including the UE, wherein the UE is configured to communicate with the radio access node.

52. The communication system of the previous 3 embodiments, wherein:
the processing circuitry of the host computer is configured to execute a host application, thereby providing the user data; and
the UE comprises processing circuitry configured to execute a client application associated with the host application.

53. A method implemented in a communication system including a host computer, a radio access node and a user equipment (UE), the method comprising:
at the host computer, providing user data; and
at the host computer, initiating a transmission carrying the user data to the UE via a cellular network comprising the radio access node, wherein the radio access node performs any of the steps of any of embodiments 1 to 41.

54. The method of the previous embodiment, further comprising, at the radio access node, transmitting the user data.

55. The method of the previous 2 embodiments, wherein the user data is provided at the host computer by executing a host application, the method further comprising, at the UE, executing a client application associated with the host application.

56. A user equipment (UE) configured to communicate with a radio access node, the UE comprising a radio interface and processing circuitry configured to performs the steps of the previous 3 embodiments.

57. A communication system including a host computer comprising a communication interface configured to receive user data originating from a transmission from a user equipment (UE) to a radio access node, wherein the radio access node comprises a radio interface and processing circuitry, the radio access node's processing circuitry configured to perform any of the steps of any of embodiments 1 to 41.

58. The communication system of the previous embodiment further including the radio access node.

59. The communication system of the previous 2 embodiments, further including the UE, wherein the UE is configured to communicate with the radio access node.

60. The communication system of the previous 3 embodiments, wherein:
the processing circuitry of the host computer is configured to execute a host application;
the UE is configured to execute a client application associated with the host application, thereby providing the user data to be received by the host computer.

1. A computer implemented method for managing resources in a Radio Access Network, RAN, of a communication network, the method, performed by a first node in the RAN, comprising:
obtaining a record of resource status information describing usage, during a historical time period, of RAN resources controlled by a second node in the RAN;
predicting, based on the obtained record, resource status information describing usage of RAN resources controlled by the second node during a future time period; and
performing at least one of:
using the predicted resource status information describing usage of RAN resources controlled by the second node in a process relating to management of RAN resources controlled by the first node; or
sending, to a third node in the RAN, a representation of the predicted resource status information describing usage of RAN resources controlled by the second node.

2. The method of claim 1, wherein resource status information describing usage of RAN resources controlled by the second node comprises at least one of the metrics:
number of active wireless devices served by the second node;
Quality of Experience measure;
Quality of Service measure;
established Radio Resource Control, RRC, Connections;
available RRC Connection capacity;
number of inactive UE contexts for wireless devices stored by the second node;
Radio Resource Status;
available Transport Network Layer resources;
capacity available over a specific radio coverage area of the second node, in uplink and/or downlink;
Slice Available Capacity, in uplink and/or downlink;
traffic for each served wireless device;
size of data arrival in uplink or downlink for a wireless device within a time period;
resource use in a part of the coverage area of the second node that is adjacent a coverage area of another node; and/or
transmission power used per resource block in uplink and/or downlink.

3. The method of claim 2, wherein predicted resource status information describing predicted usage of RAN resources controlled by the second node comprises at least one of:
any one or more of the metrics listed in claim 2;
a time window for which the predicted resource status information is valid; and/or
a measure of uncertainty and/or accuracy and/or confidence interval for the predicted resource status information.

4. The method of claim 2, wherein resource status information and predicted resource status information are obtained and/or predicted with a granularity according to at least one of the criteria:
per uplink/downlink;
per cell;
per Data Radio Bearer;
per 5G Quality of Service Indicator;
per Quality of Service Class Indicator;
per intra cell coverage area;
per network slice;
maximum, minimum, mean, average, median;
per sharing PLMN.

5. The method of claim 1, wherein predicting, based on the obtained record, resource status information describing usage of RAN resources controlled by the second node during a future time period comprises:
predicting resource status information describing usage of RAN resources controlled by the second node during a future time period based on the obtained record and on at least one of:
a record of resource status information describing usage, during a historical time period, of RAN resources controlled by the first node;
a record of resource status information describing usage, during a historical time period, of RAN resources controlled by the third node;
previously predicted resource status information describing usage of RAN resources controlled by the first node during a future or historical time period;
previously predicted resource status information describing usage of RAN resources controlled by the second node during a future or historical time period;
previously predicted resource status information describing usage of RAN resources controlled by the third node during a future or historical time period.

6. The method of claim 1, further comprising sending to the second node a request for the record of resource status information.

7. The method of claim 6, further comprising:
receiving from the second node an acknowledgment of the request.

8. The method of claim 7, wherein the acknowledgement indicates at least one of:
an extent to which resource status information metrics specified in the request sent by the first node can be provided by the second node;
an extent to which a reporting configuration specified in the request sent by the first node will be respected by the second node.

9. The method of claim 1, further comprising:
receiving from the third node a request for a representation of predicted resource status information describing usage of RAN resources controlled by the second node.

10. The method of claim 9, wherein sending to the second node a request for the record of resource status information comprises:
sending to the second node the request for the record of resource status information responsive to receiving from the third node the request for a representation of predicted resource status information describing usage of RAN resources controlled by the second node.

11. The method of claim 9, wherein the request for a representation of predicted resource status information describing usage of RAN resources controlled by the second node comprises:
a list of cells served by the second node and for which prediction of resource status information metrics is requested.

12. The method of claim 9, wherein the request for a representation of predicted resource status information describing usage of RAN resources controlled by the second node comprises at least one of:
a specification of resource status information metrics to be predicted;
a requested granularity of prediction;
a part of the communication network for which prediction is requested;
a reporting configuration for providing the requested representation.

13. The method of claim 12, wherein the specification of resource status information metrics to be predicted comprise any one or more of the metrics listed in claim 2 or claim 3.

14. The method of claim 9, further comprising:
sending to the third node an acknowledgement of the request for a representation of predicted resource status information describing usage of RAN resources controlled by the second node.

15. The method of claim 14, further comprising:
determining, based on the acknowledgment received from the second node, an extent to which the representation of predicted resource status information describing usage of RAN resources controlled by the second node, requested by the third node, can be provided; and including in the acknowledgement to the third node at least one of:
the determined extent to which the representation of predicted resource status information describing usage of RAN resources controlled by the second node, requested by the third node, can be provided;
an extent to which a reporting configuration specified in the request sent by the third node will be respected by the first node.

16. The method of claim 1, wherein sending, to the third node, a representation of the predicted resource status information describing usage of RAN resources controlled by the second node comprises:
sending the representation on fulfillment of a trigger condition comprising at least one of a timer or a threshold for a predicted metric.

17. The method of claim 1, further comprising:
obtaining, from the second node, a record of resource status information describing usage, during the future time period, of RAN resources controlled by the second node; and
comparing the obtained record of resource status information to the predicted resource status information.

18. The method of claim 17, further comprising:
updating, based on the comparison, a process for predicting resource status information describing usage of RAN resources controlled by the second node.

19. The method of claim 1, wherein
predicting, based on the obtained record, resource status information describing usage of RAN resources controlled by the second node and during a future time period comprises using a Machine Learning, ML, process to predict the resource status information.

20. (canceled)

21. A computer implemented method for managing resources in a Radio Access Network, RAN, of a communication network, the method, performed by a third node in the RAN, comprising:
receiving, from a first node in the RAN, a representation of predicted resource status information describing usage of RAN resources controlled by a second node in the RAN during a future time period; and
using the predicted resource status information describing usage of RAN resources controlled by the second node in a process relating to management of RAN resources controlled by the third node.

22-36. (canceled)
